(19) United States
(12) Patent Application Publication
(10) Pub. No.: US 2007/0253561 A1
(43) Pub. Date: Nov. 1, 2007

(54) Systems and methods for audio enhancement

(75) Inventors: Edwin Williams, University Park, FL (US); Elizabeth Coffin, St. Petersburg, FL (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: TSP Systems, Inc.

(21) Appl. No.: 11/411,831

(22) Filed: Apr. 27, 2006

(51) Int. Cl. H04R 29/00

(52) U.S. Cl. 381/58; 600/28

(57) ABSTRACT

Systems, methods, and computer program products for monitoring, in real time, acoustic characteristics of an audio environment are provided. The audio environment may include a plurality of sound sources that convert input signals to first sound streams and may include undesired objects producing second sound streams. The method may include monitoring one or more of the input signals and generating, by a plurality of acoustic sensors, one or more output signals corresponding to the first sound streams and the second sound streams. The method may also include calculating attenuation and delay values between the input signals and the output signals. Further, the method may include using the attenuation and delay values to identify portions of the output signals corresponding to second sound streams.

### TECHNICAL FIELD

This invention relates generally to audio systems and, more particularly, a system and method for providing a desired sound field to a specified listener location in an audio environment.

### BACKGROUND

Audio systems, such as home theater systems, are widely used. These audio systems may be designed to operate with a specified number of speakers. By positioning the speakers at pre-determined locations, listeners may enjoy a balanced audio environment.

However, while the speakers are designed to operate in a pre-determined arrangement, often the audio environment is not conducive to that arrangement. For example, listeners may install the audio systems in rooms having varying shapes and sizes, which can change the speaker arrangement needed to achieve a balanced audio environment. The rooms may also include objects that change the way sound is perceived by a listener. For example, a room may have sofas, chairs, tables, and other objects that deflect and absorb sound traveling from the speakers to a listener.

The audio environment may also include audio disturbances, such as noise generated by other items in the room. For example, a refrigerator or a fan may generate a continuous noise that disturbs the balance of sound being perceived by the listener. Shorter audio disturbances may also occur, such as when an emergency vehicle drives by with a siren on, or when people are talking in the room.

Due to the varying shapes of audio environments, objects in the room, and audio disturbances, the sounds transmitted by the audio system may become distorted at the listener location. As a result, the listener does not perceive the sounds transmitted by the speakers in a balanced manner. This detracts from the listening experience and may cause the listener to become distracted.

Accordingly, a need exists for an audio system and method that corrects for the layout of an audio environment. A need also exists for an audio system and method that can detect and account for objects in an audio environment. Further, a need exists for an audio system and method that identifies and cancels noise.

Systems and methods consistent with the invention provide a desired sound field to a specified listener location in an audio environment by correcting for imperfections in the audio environment.

### SUMMARY

Consistent with the invention, methods, apparatus, and computer-readable media for providing a desired sound field to a specified listener location in an audio environment are provided.

Systems, methods, and computer program products for monitoring, in real time, acoustic characteristics of an audio environment are provided. The audio environment may include a plurality of sound sources that convert input signals to first sound streams and may include undesired objects producing second sound streams. The method may include monitoring one or more of the input signals and generating, by a plurality of acoustic sensors, one or more output signals corresponding to the first sound streams and the second sound streams. The method may also include calculating attenuation and delay values between the input signals and the output signals. Further, the method may include using the attenuation and delay values to identify portions of the output signals corresponding to second sound streams.

It is to be understood that both the foregoing general description and the following detailed description are exemplary and explanatory only and are not restrictive of the invention, as claimed. The accompanying drawings, which are incorporated in and constitute a part of this specification, illustrate embodiments consistent with the invention and together with the description, serve to explain the principles of the invention.

### BRIEF DESCRIPTION OF THE DRAWINGS

FIG. 1 illustrates an exemplary audio environment consistent with the invention.

FIG. 2 illustrates an exemplary functional block diagram of a system consistent with the invention.

FIG. 3A illustrates an exemplary structural block diagram of the system of FIG. 2, consistent with the invention.

FIG. 3 illustrates a flowchart of an exemplary method for providing a desired sound field to a specified listener location in an audio environment, consistent with the invention.

FIG. 4 is an exemplary functional block diagram of a navigation module of FIG. 2, consistent with the invention.

FIG. 5 illustrates a flowchart of an exemplary method for mapping the audio environment of FIG. 1 by the navigation module of FIG. 2, consistent with the invention.

FIG. 6 illustrates exemplary sound streams received by acoustic sensors of FIG. 1, consistent with the invention.

FIG. 7 illustrates a flowchart of an exemplary operation of a correlation component of FIG. 4, consistent with the invention.

FIG. 8 illustrates a flowchart of an exemplary method performed by a filter of FIG. 4, consistent with the invention.

FIG. 9 illustrates a flowchart of an exemplary method for stripping noise from the signals from acoustic sensors, consistent with the invention.

FIG. 10 illustrates an exemplary functional block diagram of a pattern recognition component of FIG. 4, consistent with the invention.

FIG. 10A illustrates an exemplary diagram of Fourier coefficients as a function of time, consistent with the invention.

FIG. 10B illustrates an exemplary functional diagram of a neural network, consistent with the invention.

FIG. 11A illustrates an exemplary layout of speakers in audio environment of FIG. 1, consistent with the invention.

FIG. 11 illustrates a flowchart of an exemplary method for determining the location of speakers in an audio environment of FIG. 1, consistent with the invention.

FIG. 12A illustrates an exemplary arrangement of actual noise sources and virtual noise sources in an audio environment of FIG. 1, consistent with the invention.

FIG. 12 illustrates a flowchart of an exemplary method performed by a noise location component of FIG. 4, consistent with the invention.

FIG. 13 illustrates a flowchart of an exemplary method performed by a conjugate method component of FIG. 4, consistent with the invention.

FIG. 14A illustrates an exemplary arrangement of five speakers and a specified listener location in an audio environment of FIG. 1, consistent with the invention.

FIG. 14B illustrates exemplary distances between each of the speakers in FIG. 14A, consistent with the invention.

FIG. 14 illustrates a flowchart of an exemplary method that may be performed by a coordinate frame component of FIG. 4, consistent with the invention.

FIG. 15 illustrates a flowchart of an exemplary method that may be performed by a sonic estimation component of FIG. 4, consistent with the invention.

FIG. 16 illustrates an exemplary functional block diagram of a guidance module of FIG. 2, consistent with the invention.

FIG. 17 illustrates an exemplary functional block diagram of a steering module of FIG. 2, consistent with the invention.

FIG. 18 illustrates a flowchart of an exemplary method that may be performed by a steering module of FIG. 17, consistent with the invention.

FIG. 19 illustrates a flowchart of an exemplary method that may be performed by a noise steering component of FIG. 17, consistent with the invention.

FIG. 20 illustrates an exemplary functional block diagram of a control section of a steering and control module of FIG. 2, consistent with the invention.

FIG. 21 illustrates a flowchart of an exemplary method that may be performed by a post-mixer component of FIG. 20, consistent with the invention.

FIG. 22 illustrates a flowchart of an exemplary method performed by the system of FIG. 2, consistent with the invention.

### DETAILED DESCRIPTION

Reference will now be made in detail to the exemplary embodiments of the invention, examples of which are illustrated in the accompanying drawings. Wherever possible, the same reference numbers will be used throughout the drawings to refer to the same or like parts.

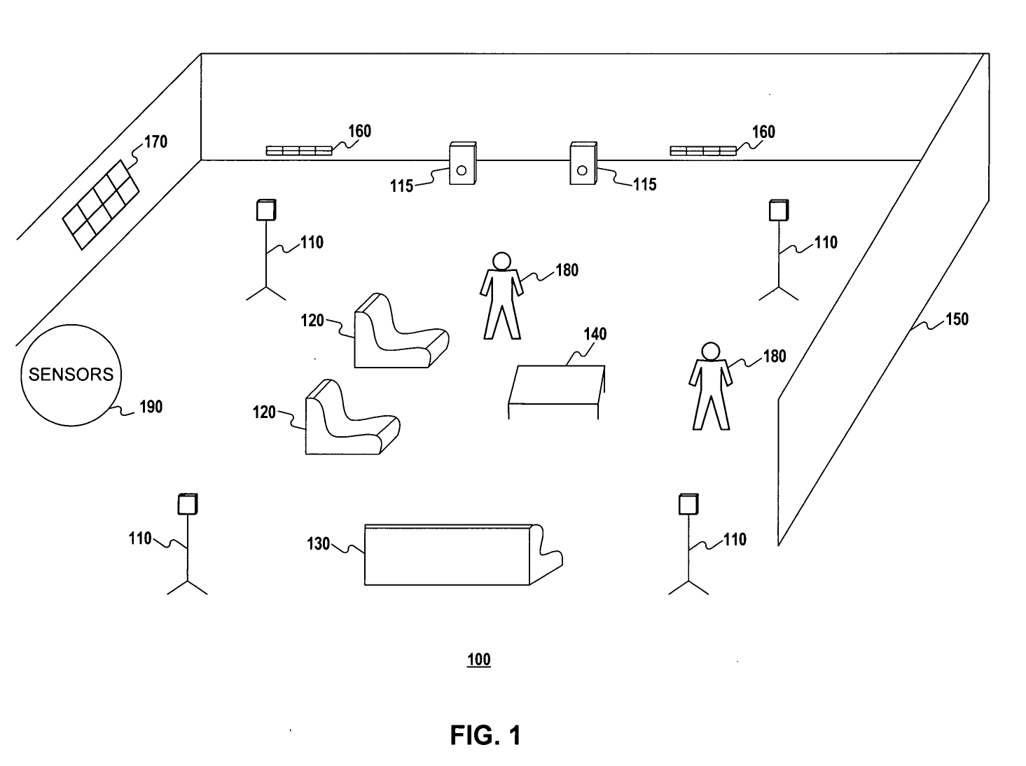

FIG. 1 illustrates an exemplary audio environment 100 consistent with the invention. Audio environment 100 may include, for example, objects, sound sources (such as speakers), and noise sources. As described in detail below, systems and methods consistent with the invention may analyze the acoustic characteristics of audio environment 100 and generate audio signals which correct for imperfections in audio environment 100, correct for imperfections in the position of speakers, correct for noise, and correct for imperfect speaker characteristics. Acoustic environment 100 may be monitored in real-time, allowing continuous correction of imperfections. In this manner, a desired sound field may be reproduced for listeners or recording equipment in audio environment 100.

In general, audio output signals supplied to speakers may be monitored, sensors (such as microphones) create output signals from a sound field generated in the audio environment, signals may be digitized, and the digitized signals may be analyzed and processed. The audio output signals may then be modified to generate a desired sound field at a specified listener location in the audio environment.

Audio environment 100 may include one or more sound sources, such as speakers 110 and 115. Speakers 110 and speakers 115 may be of a variety of sizes and may have different capabilities. For example, speakers 110 may be used for mid range and high audio frequencies, while speakers 115, such as subwoofers, may be used for low audio frequencies. Speakers 110 and 115 may generate sound streams, that is, acoustic waves extending over time, from one or more audio signals outputted by audio processing equipment. A user may place speakers 110 and speakers 115 at locations of their choice throughout audio environment 100. A center channel speaker may be placed at the location from which the user would like for the center sound to be coming, such as the above or below a television screen.

Audio environment 100 may also include one or more objects that attenuate, deflect, and/or alter the sound streams generated by speakers 110 and 115. For example, audio environment 100 may include furniture such as chairs 120, a sofa 130, and a table 140. While these objects may include furniture, audio environment 100 may include a plurality of other types of objects that alter the sound streams transmitted by speakers 110 and 115, such as walls 150.

Audio environment 100 may further include sound streams produced by one or more sources of undesired acoustic disturbances. These sources may also be referred to as noise sources. In this application, noise may be defined as acoustic waves that disturb perception of a desired sound stream from a sound source. For example, air vents 160 may introduce noise into audio environment 100. Window 170 may allow noise from outside, such as a passing lawn mower or an emergency vehicle, to enter audio environment 100. Moreover, people 180 may create noise, such as by talking, singing, whistling, etc. The totality of acoustic effect produced at a given location by all sound and noise sources may be referred to as a “sound field.”

An acoustic sensor array 190 in the form of a handheld device with a user interface may be placed within audio environment 100. Sensor array 190 may include a plurality of acoustic transducers, such as microphones, arranged in a pattern to receive sound streams from all directions. Sensor array 190 also includes circuitry to convert analog signals supplied by the microphones into digital sound signals. Sensor array 190 may be provided within a single unit and may include directional microphones.

A user may hold sensor array 190 at a desired listening location, and press a button to initialize the system. The user initializes sensor array 190 at the desired listening location to designate a location at which to create a desired sound field. Initialization of the system will be described in more detail below. Once initialization is complete, the user may place sensor array 190 at any location in audio environment 100. Users may be provided with recommended guidelines for the location of sensor array 190, such as to not place sensor array 190 in a closet.

As described in detail below, sensor array 190 may be used to monitor a sound field produced by sound streams in audio environment 100. Sensor array 190 may communicate wirelessly to transmit the received sound streams as digital signals for analysis. The location of sensor array 190 in audio environment 100 may be determined automatically, allowing a user to reposition sensor array 190 without having to re-initialize the system.

The microphones of sensor array 190 may be directional and may be evenly spaced in a 360° degree pattern. For example, if sensor array 190 includes three directional microphones, the microphones may be spaced at 120° angles, if five directional microphones are used, a spacing of 72° angles may be used, etc. Sensor array 190, not shown to scale in FIG. 1, may be circular with approximately a 4″ diameter, although additional sizes and shapes are possible.

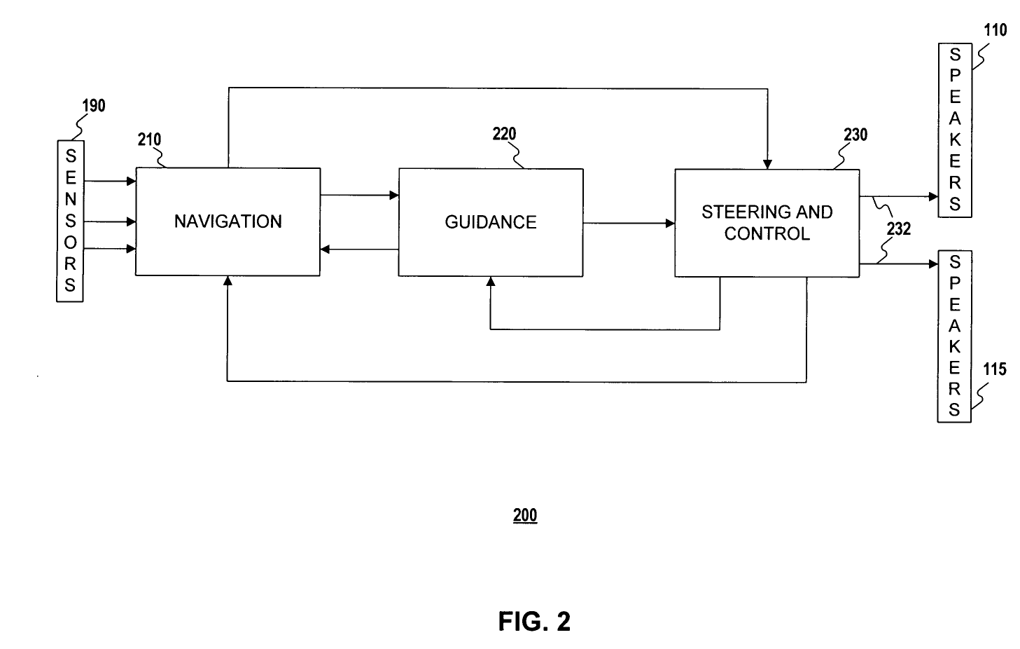

FIG. 2 illustrates an exemplary functional block diagram of a system 200 consistent with the invention. Three exemplary modules may be used to produce desired sound fields at specified listener locations in an audio environment: a navigation module 210, a guidance module 220, and a steering and control module 230.

Navigation module 210 may map audio environment 100 relative to a specified listener location. For example, navigation module 210 may receive output signals from sensor array 190 to map audio environment 100 (FIG. 1) in the vicinity of a listening position such as sofa 130, chair 120, or any other location. Mapping may include the process of determining relative locations in audio environment 100, such as locations of objects, sound sources, and noise sources; a specified listening location; the location of a base speaker (e.g., a center channel speaker); and the location of sensor array 190. The process of mapping may also be referred to as establishing an acoustic profile of audio environment 100. After initialization, navigation module 210 may be operated to monitor the location of sensor array 190 within audio environment 100.

Once navigation module 210 maps audio environment 100, the determined locations may be provided to guidance module 220. Guidance module 220 may be used to define a desired sound field at a specified listener location in audio environment 100, such as at sofa 130, taking into account the map of objects, sound sources, and acoustic disturbances in audio environment 100.

Steering and control module 230 may receive from guidance module 220 one or more signals that will be processed and supplied as output signals 232 to speakers 110 and 115 to generate a desired sound field. Steering and control module 230 may also determine and create a correct mix of signals to generate sound streams sufficient to achieve the desired sound field. In particular, steering and control module 230 may adjust the proportions, amplitude, timing, and frequency of signals 232 to generate sound streams that produce the desired sound field at a specified listener location in audio environment 100.

As illustrated in FIG. 2, navigation module 210, guidance module 220, and steering and control module 230 may provide feedback to each other. That is, navigation module 210 may be updated by signals from guidance module 220 and steering and control module 230, guidance module 220 may be updated by signals from navigation module 210 and steering and control module 230, and steering and control module 230 may be updated by signals from navigation module 210 and guidance module 220. As described in detail below, navigation module 210, guidance module 220, and steering and control module 230 may dynamically update input signals to speakers 110 and 115, accounting for changes in audio environment 100 as they occur, and predicting noise. While navigation module 210, guidance module 220, and navigation and control 230 are illustrated and described in FIG. 2, additional modules may be used to achieve a desired sound field at a specified listener location in audio environment 100.

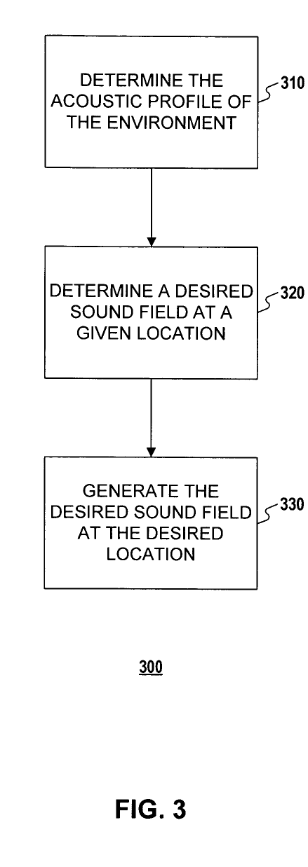

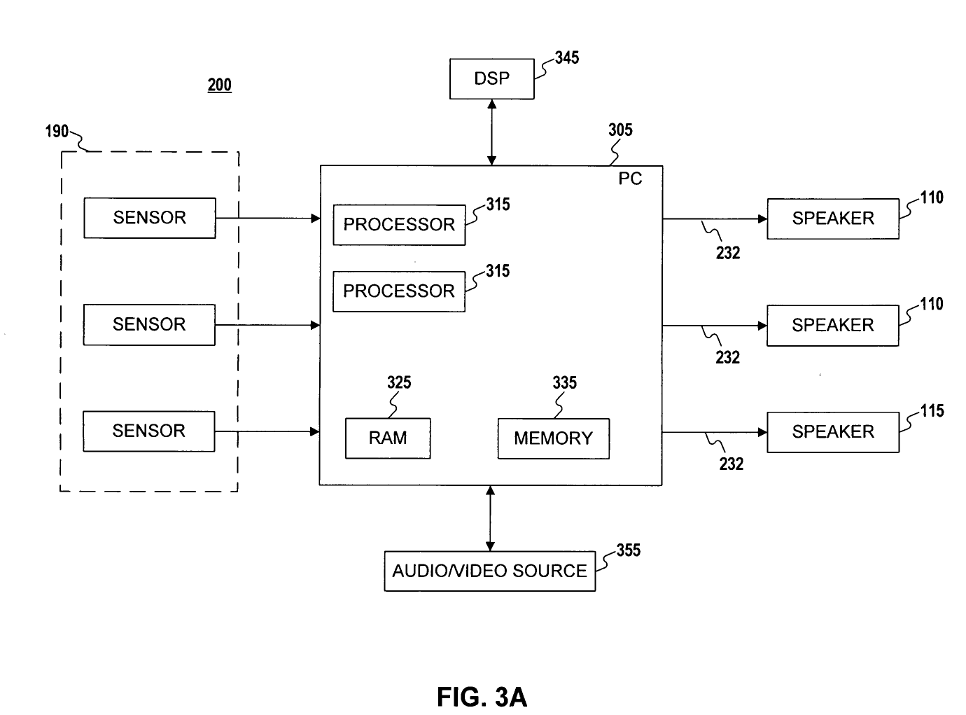

FIG. 3A illustrates an exemplary structural block diagram of system 200 consistent with the invention. System 200 may include sensor array 190, a processor 305, a digital signal processor (DSP) 345, an audio/video (AN) source 355, and speakers 110 and 115. Processor 305 may be, for example, a personal computer.

Sensor array 190 may generate digitized audio signals and transmit the digitized signals to processor 305 for processing. For example, the audio signals may be converted into pulse code modulation signals. Alternatively, analog audio signals may be transmitted by sensor array 190 and digitized by processor 305. Additional methods for processing and transferring the audio signals may be used, such as, for example, audio compression schemes. The digitized signals may be processed by processor 345, optionally with the aid of one or more digital signal processors 345.

Processor 305 may receive and process the audio signals from sensor array 190, as described in detail below. Processor 305 may include one or more central processing units (CPUs) 315 to process the audio signals, map audio environment 100, define a desired sound field at a specified listener location, determine a mix of signals, and supply the mix as signals 232 to speakers 110 and 115 to provide the desired sound field.

Signals 232 to speakers 110 and 115 are shown in FIG. 3A as being directly supplied by processor 305. However, it is to be understood that in many applications an amplifier (not shown) will be required to increase the power of signals supplied by processor 305 to a level sufficient to drive speakers 110 and 115.

Processor 305 may also include RAM 325, memory 335, input/output ports, and other components commonly included with personal computers and audio/video equipment. Processor 305 may also utilize parallel-processing to execute algorithms of the modules and components in system 200.

DSP 345 may be connected to processor 305 and may provide digital signal processing of signals from sensor array 190. Alternatively, DSP 345 may not be required if processor 305 exhibits sufficient processing power to perform digital signal processing via software. Various numbers of sensor array 190, PCs 305, digital signal processors 345, A/V sources 355, and speakers 110 and 115 may be included within system 200, depending on the specific application.

A/V source 355 may provide low-level source audio input signals to PC 305. Source audio input signals may comprise signals encoded for multi-channel playback, such as Dolby Pro Logic II signals. For example, A/V source 355 may be a CD player, an AM/FM tuner, another personal computer, a television receiver, an amplifier, a broadcast receiver, an MP3 player, a DVD player, a video game source, or another A/V source. Processor 305 may receive the source audio input signals from A/V source 355 and modify these signals as determined by output signals from sensor array 190, as described below, to provide a desired sound field at a specified listener location in audio environment 100.

While illustrated as a separate device, A/V source 355 may also be included within PC 305. That is, processor 305 may include a CD drive, a DVD drive, a MP3 player, a radio tuner, etc, in order to reduce the number of “boxes” in the system. In this embodiment, the functionality of system 200 may be provided by software that manipulates the output from the A/V source 355 and the input to speakers 110 and 115. That is, system 200 may be implemented as software that does not change, modify, or alter the generation of signals by A/V source 355; rather, system 200 may re-mix the signals provided by the source material to correct for imperfections in audio environment 100.

System 200 may allow for easier set-up of speakers (e.g., installation, positioning, and balancing) in audio environment 100 by a user. Audio/video source 355 and PC 305 may include output terminals corresponding to speakers 110 and 115. These output terminals may be associated with specified speaker locations. For example, the output terminals may be labeled “left,” “right,” “surround left,” “surround right,” and “center.” Because system 200 can determine the locations of speakers 110 and 115 in audio environment 100, a user need not provide a one-to-one relationship between speakers 110 and 115 and output terminals of A/V source 355. Rather, a user may connect various numbers of speakers 110 and 115 in any manner without regard to the specified speaker locations, and system 200 may ensure that speakers 110 and 115 produce sounds as if they were in the specified speaker locations. For example, a user may connect a speaker that is actually located at a left surround position in audio environment 100 (FIG. 1, speaker 110 to the left of couch 130) to the A/V output terminal that is specified for the right surround speaker (FIG. 1, speaker 110 to the right of couch 130). As a result, the sound streams generated by speakers 110 and 115 may not be balanced. However, system 200 may correct for this imperfection in the setup by modifying or replacing the signal 232 generated by the right surround speaker output terminal for use at an ideal speaker location with an audio signal that will be supplied to the left surround speaker 110 at its actual location.

FIG. 3 illustrates a flowchart of an exemplary method 300 for providing a desired sound field at a specified listener location in audio environment 100, consistent with the invention. Steps 310, 320, and 330 may be performed by navigation module 210, guidance module 220, and steering and control module 230, respectively.

At step 310, navigation module 210 (FIG. 2) may determine the acoustic profile of audio environment 100. This may include, for example, determining the location of objects, sound sources, and noise sources in audio environment 100 by measuring amplitudes and delays of sound streams. Navigation module 210 may monitor input signals supplied to speakers 110 and 115 and compare these input signals to output signals generated by sensor array 190. The user may position sensor array 190 in the specified listener location, and press a button to initialize system 200. System 200 may then play a range of test sounds through speakers 110 and 115 to determine the location of objects, speakers 110 and 115 (including the center channel), and the specified listener location in audio environment 100. If a user does not want the center channel speaker to be the location from which sound streams are centered (“source location”), the user may specify another location by, for example, pressing a button on sensor array 190 while the user is physically positioned at that location.

The range of test sounds may cover multiple frequency ranges, and may be unique such that the range of test sounds is associated with system 200. Each speaker 110 and 115 may receive unique test tones to aid in identifying the locations of speakers 110 and 115. For example, the range of test sounds may be white noise or a unique pattern of tones with a flat Fourier response that is pleasing to a user.

At step 320, guidance module 220 (FIG. 2) may define a desired sound field at one or more specified listener locations in audio environment 100. The specified listener location may be identified by a user during initialization. Defining a desired sound field at a specified listener location will be described in more detail below.

At step 330, steering and control module 230 (FIG. 2) may generate signals 232 to produce a desired sound field at the specified listener location. Steering and control 230 may create one or more “mixing laws” and then implement the mixing laws to generate the desired sound field. Mixing laws may include one or more processing algorithms designed to alter signals 232, as set forth below. Steering and control module 230 may create the mixing laws using data provided by navigation module 210 and guidance module 220. Steering and control module 230 may then implement the mixing laws to create altered signals 232 supplied to speakers 110 and 115 sufficient to generate a desired sound field at a specified listener location in audio environment 100.

Implementation of the mixing laws may include attenuating the effect of noise streams, increasing the amplitude of signals 232, decreasing the amplitude of signals 232, delaying signals 232, advancing signals 232, and altering frequencies of signals 232. Additional modifications to and mixing of input signals to speakers 110 and 115 may be utilized to provide the desired sound field to a specified listener location in audio environment 100.

Navigation Module 210

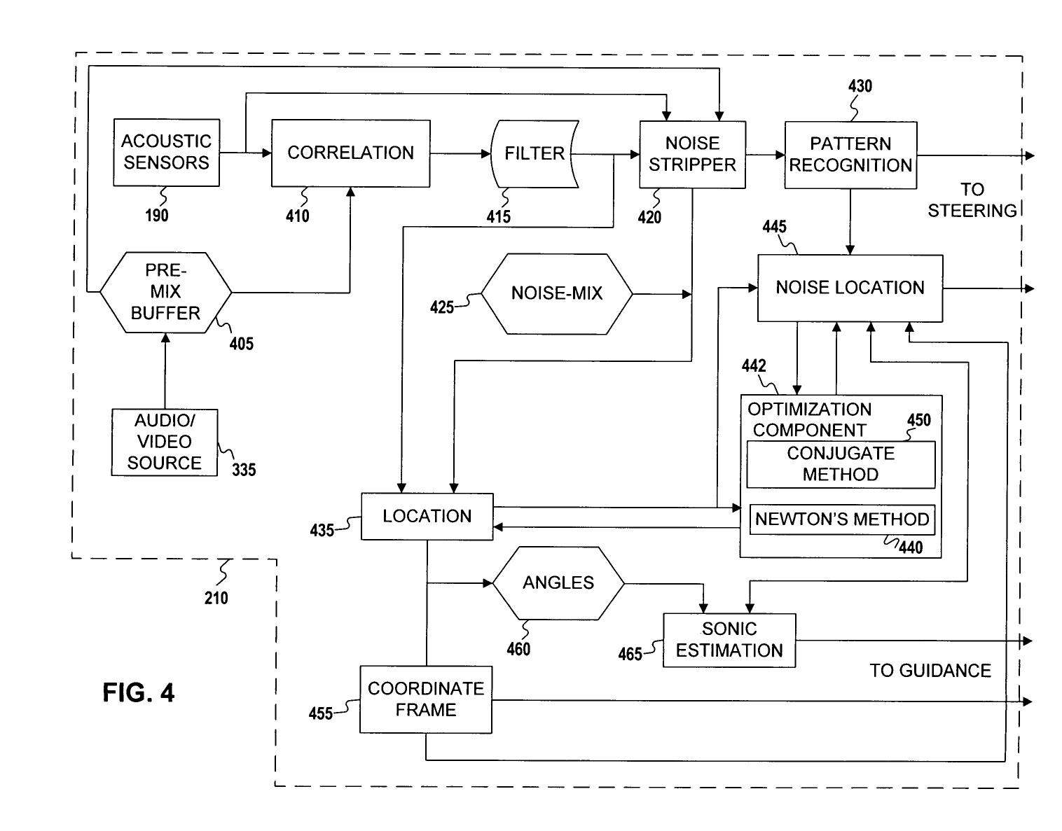

FIG. 4 is an exemplary block diagram of navigation module 210 (FIG. 2) consistent with the invention. Navigation module 210 may map the acoustic characteristics of audio environment 100 using signals generated by sensor array 190. Navigation module 210 may include, for example, a pre-mix buffer 405 which receives signals generated by audio/video source 355, a correlation component 410, a filter 415, a noise stripper component 420, a noise-mix component 425, a pattern recognition component 430, and a location component 435. Navigation module 210 may further include an optimization component 442 including a Newton's method component 440 and a conjugate method component 450, a noise location component 445, a coordinate frame component 455, an angles component 460, and a sonic estimation component 465. Outputs of navigation module 210 may be provided to both guidance module 220 and steering and control module 230. Navigation 210 may also include additional components, such as additional filters, that may be used to map the acoustic characteristics of audio environment 100. Moreover, one or more components of navigation 210 may be combined into a single component, such as by combining noise stripper 420 and pattern recognition component 430.

First, a general description of the exemplary components of navigation module 210 will be provided. This will be followed by a more detailed description.

Sensor array 190 may receive sound streams in audio environment 100 and generate audio signals from the sound streams. In generating these signals, sensor array 190 may receive analog signals from microphones and generate coded digital electrical signals in the form of pulse code modulation signals. These signals may be transmitted to system 200 via, for example, a wireless channel.

The sound streams that sensor array 190 receives may include output streams generated by speakers 110 and 115, as well as noise streams in the form of acoustic disturbances generated by noise sources. An acoustic disturbance may be any item in audio environment that generates a sound that is not part of the desired sound field. An acoustic disturbance may be generated by, for example, air vents 160, people 180, or other sources that generate noise. Noise streams may also include reflected sounds streams, such as an echo of speaker sound streams reflected by walls 150.

Noise may also be generated by speakers 110 and 115 in the form of distortion, such as when the amplitude of a signal 232 exceeds linear transducing characteristics of the speaker. System 200 may utilize harmonic distortion patterns of speakers 110 and 115 and the audio signals from sensor array 190 to correct for imperfections and variations in speaker characteristics. While several exemplary noise sources have been described, additional noise sources may be present in and detected in audio environment.

Correlation component 410 may compare the source signals generated by A/V source 355 and supplied through pre-mix buffer 405 to the signals generated by sensor array 190 and calculate attenuation and delay values between the source signals and the signals from sensor array 190. An attenuation value may be the ratio of acoustic pressure from sound streams measured by sensor array 190 compared to the acoustic pressure generated by sound sources (e.g., speakers 110 and 115). Correlation component 410 may be used to determine how similar or dissimilar two signals are, in this case, signals 232 provided to speakers 110 and 115, and the signals provided by sensor array 190.

Filter 415 may average the outputs of correlation component 410 and provide these averages to noise stripper component 420 and location component 435. Noise stripper component 420 may determine what part of the audio signals from sensor array 190 is noise. Noise stripper component 420 may separate the noise signals and provide these to pattern recognition component 430. Pattern recognition component 430 may determine an underlying noise pattern from the noise signals provided by noise stripper component 420. Pattern recognition component 430 may be implemented, for example, using a neural network. Pattern recognition component 430 may predict a pattern of noise signals and provide these to steering and control module 230, which may modify a mixing law to create acoustic output from speakers 110 and 115 to cancel the predicted noise signals at the appropriate time. The pattern of noise signals may be represented as noise vectors, having a direction and an amplitude.

Noise location component 445 may estimate the location of noise sources in audio environment 100. As described in more detail below, the location of noise sources may be estimated using virtual noise sources. A virtual noise source may be defined as a hypothetical noise source at a location determined such that the virtual noise source duplicates the properties of one or more actual noise sources in audio environment 100. Noise location component 445 may utilize optimization component 442 and coordinate frame component 455 to establish the location of noise sources.

Location component 435 may determine the location of speakers 110 and 115 within audio environment 100. As described in detail below, location component 435 may utilize optimization component 442 and Newton's approximation method 440 to establish the location of speakers 110 and 115.

Coordinate frame component 455 may create coordinate frames, that is, coordinate systems, in audio environment 100 to identify and specify the best possible listening location. Coordinate frames may be centered upon a location of interest in audio environment 100. For example, coordinate frame component 455 may establish a listener coordinate frame, an acoustic sensor coordinate frame, a sound source coordinate frame, and an acoustic sensor location coordinate frame, although additional coordinate frames may be created. Locations in the coordinate frames may be established and points in the coordinate frames may be specified.

The listener coordinate frame may have an origin, that is, may be centered, at the specified listener location that a user identified during initialization. The x coordinate may be the line from the specified listener location to a specified speaker (e.g., center channel speaker), and the y coordinate may be orthogonal to the x coordinate in the direction of increasing theta from sensor array 190. The listener coordinate frame may remain fixed unless a user re-initializes system 200 to, for example, change the specified listener location.

The acoustic sensor coordinate frame may have an origin at the location of sensor array 190. The origin may be determined and monitored by navigation module 210 using the angles from the sensor array 190 to speakers 110 and 115. The x coordinate may be a line from sensor array 190 to a specified speaker (e.g., the center channel speaker), and the y coordinate may be orthogonal to the x coordinate in the direction of increasing theta from sensor array 190. The acoustic sensor coordinate frame may be continuously updated in real-time to account for a user moving sensor array 190.

The sound source coordinate frame may have an origin at a specified speaker (e.g., center channel speaker) and may be non-orthogonal. The principal directions may be lines from the specified speaker to the two other speakers that are furthest apart from each other, and which are not co-linear with the specified speaker. The source coordinate frame may be established during initialization and may remain in a fixed location, unless a user re-initializes system 200.

Sonic estimation component 465 may estimate the characteristics of the sound field at the specified listener location in audio environment 100. As described in detail below, sonic estimation component 465 may create a gain matrix for the specified listener location, which may be used by noise location component 445 and steering and control module 230.

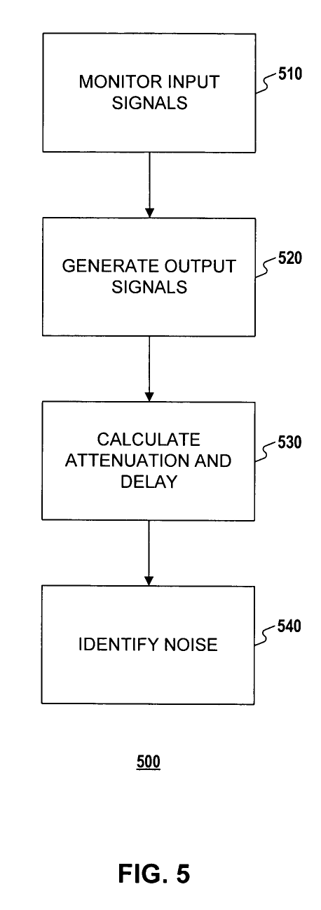

FIG. 5 illustrates a flowchart 500 of an exemplary method for mapping audio environment 100 (FIG. 1) by navigation module 210 (FIG. 2), consistent with the invention. Additional details and steps for mapping audio environment 100 will be provided below.

At step 510, navigation module 210 may monitor input signals 232 sent to speakers 110 and 115. These input signals may include signals in a pre-mix buffer 405 from audio/video source 355, signals in a post-mix buffer, and one or more source audio input signals.

At step 520, navigation module 210 may receive generated audio signals from sensor array 190 from sound streams that sensor array 190 detect.

At step 530, navigation module 210 may calculate an attenuation and a delay between the acoustic sound streams generated by speakers 110 and 115 using input signals 232 and the receipt of the acoustic sound streams, as generated by sensor array 190.

At step 540, navigation module 210 may use the attenuation and delay values calculated in step 530 to identify portions of the audio signals from sensor array 190 that correspond to noise signals.

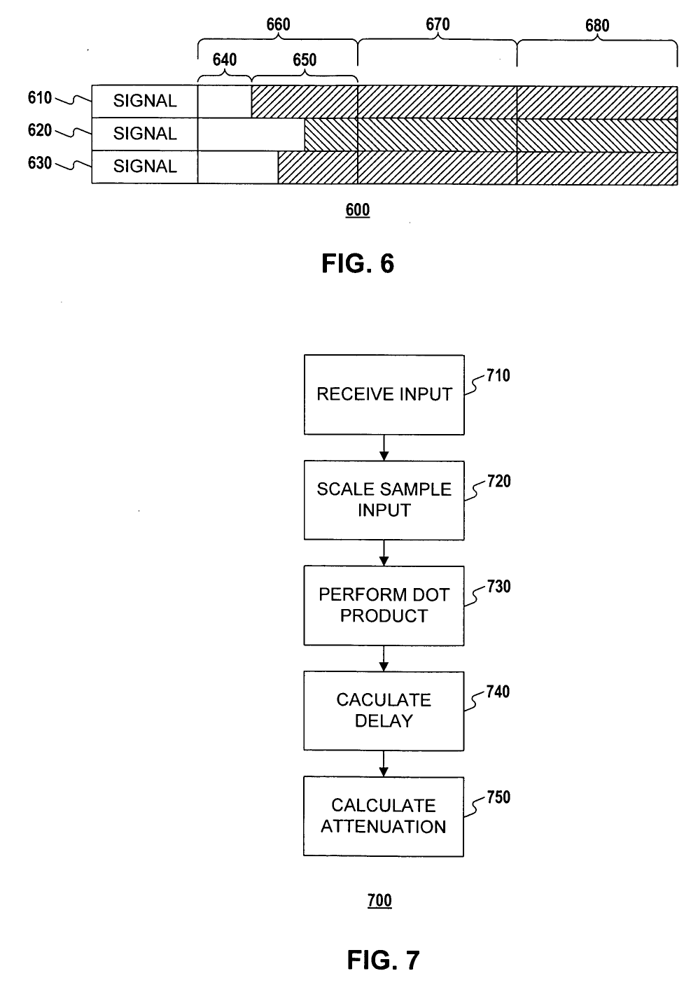

FIG. 6 illustrates exemplary sound streams received by sensor array 190, consistent with the invention. The horizontal axis of FIG. 6 represents time. Sensor array 190 may generate sound signals representing samples from sound streams in sample groups 660, 670, and 680. As discussed above, sensor array 190 may include a plurality of microphones, and each microphone may generate a sound signal based on the detected sound streams. For example, if three microphones are provided by sensor array 190, three sound signals may be generated by sensor array 190: sound signal 610, sound signal 620, and sound signal 630. Sensor array 190 may create a buffer for each microphone's sound signal, generate digital values for the sound signals, and wirelessly transmit the digital values to system 200. The samples may be taken at, for example, 96 kHz with 24-bit resolution.

The sound signals generated by each microphone may have separate delay values due to the directional nature of the microphones and the layout of audio environment 100. For example, sound signal 610 may have a real delay 640. Real delay 640 may be a time period during which sensor array 190 did not receive any sound streams. During this time period, no signal may be generated for correlation component 410. Correlation delay 650 may be the delay returned by correlation component 410, which may be the difference between the total time represented by sample group 660 and real delay 640.

FIG. 7 illustrates a flowchart of an exemplary method that may be performed by correlation component 410 (FIG. 4), consistent with the invention. Correlation component 410 may determine an amount of correlation between the audio signals from sensor array 190 and the input signals to speakers 110 and 115. Correlation component 410 may calculate delay and attenuation values using matrices having a size in one dimension equal to the number of sound streams and a size in another dimension equal to the number of sensor array 190. Correlation component 410 may use primes by matching the highest signal generated by sensor array 190 with the highest input to speakers 110 and 115.

At step 710, correlation component 410 may begin receiving input. Correlation component 410 may receive a pre-mix signal from pre-mix buffer 405 (also referred to as buffered input), audio signals from sensor array 190 (also referred to as sampled input), and delay values. By receiving audio signals from pre-mix buffer 405, correlation component 410 may compare the audio signals 232 that were sent to speakers 110 and 115 to the audio signals that generated by sound streams at the specified listener location.

Buffered input may be of different length compared to the sampled input because buffered input may include both the current sampled input and the sampled input from the previous sample. The number of vectors in buffered input may be equal to the number of sound streams generated by speakers 110 and 115. Sampled input may be a vector set of integer values received by sensor array 190. Sampled input may be used by correlation component 410 to determine the attenuation and delay of sound streams between speakers 110 and 115 and sensor array 190. The delay values received by correlation component 410 may be estimated delays, which can be used to increase processing speed. The delay values may be provided as feedback within correlation component 410, and may be in the form of vectors for each speaker 110 and 115. The vectors of delay values may initially be a null set during real delay 540.

At step 720, if there are no estimated delay values (delay values is a null vector), correlation component 410 may scale the sampled input. Sampled input may be scaled by executing an algorithm to limit the absolute values of the sample input range, so that very large or very small values do not distort the maximum correlation function. For example, a range with a minimum of −1 and a maximum of 1 may be used, and an exemplary pseudo code scaling algorithm for sampled input may be expressed as follows:

$$Sample\_Prime = \frac{SAMPLED\_INPUT ( i , : )}{max ( abs ( min\_sample ) , max\_sample )}$$

where i=a counting index from 1 to the number of microphones; SAMPLED_INPUT=the data from the sensor stream; min-sample=the minimum value in SAMPLED_INPUT; max_sample=the maximum value in SAMPLED_INPUT; and Sample_Prime=a scaled SAMPLED_INPUT that makes the input between −1 and +1.

Scaling may be implemented using a similar method for buffered input, except that the length of the vector for buffered input may be truncated to match the size of Sample_Prime. Scaling of buffered input may be implemented by executing an algorithm. An exemplary pseudo code scaling algorithm for buffered input may be expressed as follows:

l = length(Sample_Prime);
min_buffered = min[BUFFERED_INPUT(j,:)];
max_buffered = max[BUFFERED_INPUT(j,:)];
do{
Buffered_Prime = BUFFERED_INPUT[j,(k:k + l − 1)];
${Buffered}_{—} Prime = \frac{2 * {Buffered}_{—} Prime}{{max}_{—} buffered - {min}_{—} buffered} - \frac{{max}_{— } buffered + {min}_{—} buffered}{{max}_{—} buffered - {min}_{—} buffered} ;$

where l is the number of data points in SAMPLE_PRIME; BUFFERED_INPUT is the data in the input signals to speakers 110 and 115; j is a counting index from 1 to the number of speakers; min_buffered is the minimum value in BUFFERED_INPUT; max_buffered is the maximum value in BUFFERED_INPUT; k is a counting index from 1 to l; and Buffered_Prime is a scaled BUFFERED_INPUT that makes the data from −1 to +1.

At step 730, a dot product may be calculated using the resulting Sample_Prime and Buffered_Prime. The dot product may be calculated for all the original sound streams (index) and the potential lengths (k index). K may be the number of buffered signals generated by sensor array 190.

At step 740, the largest of the dot products may be determined. The delay from sample i to stream j may be calculated as Delay(i, j)=l−max(k).

At step 750, correlation component 410 may calculate the attenuation of the sample with an exemplary calculation (note k here is assumed to be the location of the maximum):

$$ATTEN ( i , j ) = \frac{\begin{matrix}SAMPLED\_INPUT ( i , : ) \cdot \\ BUFFERED\_INPUT [ j , ( k : k + l - 1 ) ]\end{matrix}}{\begin{matrix}BUFFERED\_INPUT [ j , ( k : k + l - 1 ) ] \cdot \\ BUFFERED\_INPUT [ j , ( k : k + l - 1 ) ]\end{matrix}} ;$$

If correlation component 410 has already determined the optimum delay, then step 740 may be skipped and only the attenuation returned.

Correlation component 410 may be implemented using, for example DSP chips and parallel processing. While one example of determining an amount of correlation between the audio signals from sensor array 190 and the input signals to speakers 110 and 115 using cross-correlation is described, other methods and equations may be used, such as autocorrelation.

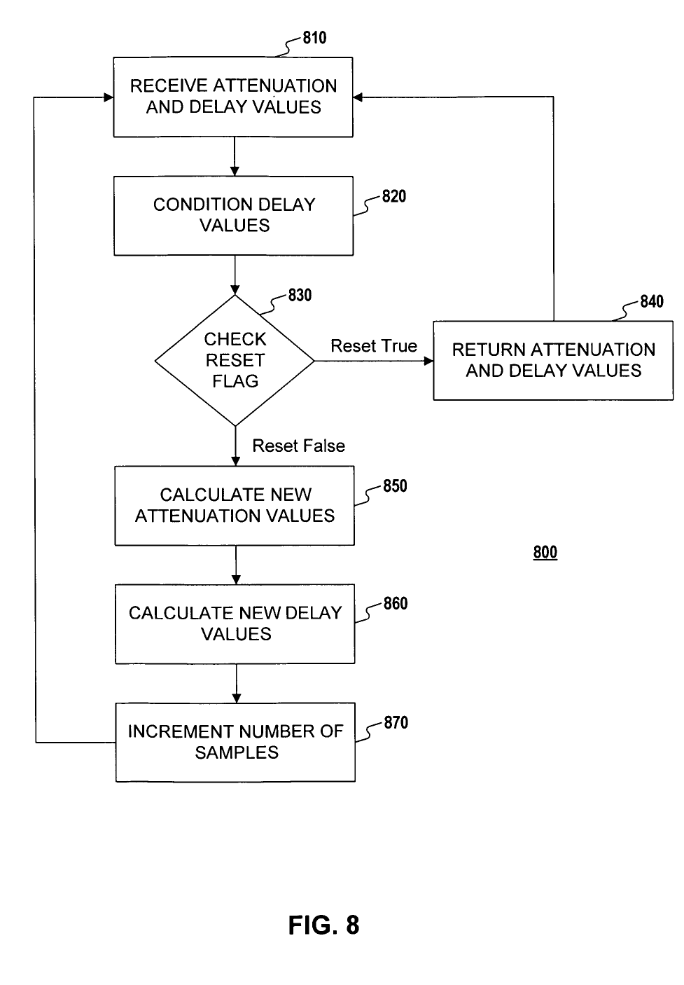

FIG. 8 illustrates a flowchart 800 of an exemplary iterative method that may be performed by filter 415 (FIG. 4), consistent with the invention. Filter 415 may average the values of the matrices output by correlation component 410 and provide the averages to noise stripper component 420 and location component 435. Filter 415 may be implemented using a variety of techniques, such as a linear filter in the form of a Kalman filter. Filter 415 may use linear transforms, unbiased errors, and Kalman Gain matrices.

Sensor array 190 may have varying error characteristics, including different measurement efficiency. By averaging the outputs of correlation component 410, filter 415 may correct for imperfections between sensor array 190.

At step 810, filter 415 may receive attenuation and delay values from correlation component 410 for a sample, as well as the average attenuation values and the average delay values from a previous iteration, if any. Filter 415 may also receive the number of samples of the previous iteration, as well as a reset flag. The attenuation and delay estimates may be weighed using covariance information.

At step 820, filter 415 may condition the delay values. The delay values may be conditioned by associating the delay from each speaker 110 and 115 with the largest attenuation value for that speaker. Filter 415 may further condition the delay values by assuming that the distance between sensors in sensor array 190 is too small for an additional delay to occur. However, in one embodiment consistent with the invention, the delay values between sensors in sensor array 190 may be calculated and utilized to obtain more precise measurements of the characteristics of audio environment 100.

At step 830, filter 415 may check a reset flag. If the reset flag is “true,” this may indicate that the received attenuation and delay values are associated with the first sample. In this case, at step 840, the average attenuation and average delay may be set equal to the received attenuation and delay values. The number of samples may be incremented, and control may return to receiving attenuation and delay values from correlation component 410 (step 810).

If the reset flag is “false,” at step 850 filter 415 may calculate a new average attenuation value to include the received attenuation value. At step 860, filter 415 may calculate a new average delay value to include the received delay value. At step 870, the number of samples may be incremented by one. Control may then return to receiving new attenuation and delay values from correlation component 410 (step 810).

Filter 415 may utilize different matrices at different times. For example, one microphone in sensor array 190 may provide samples at intervals of one second, while other microphones in sensor array 190 may provide samples at half second intervals.

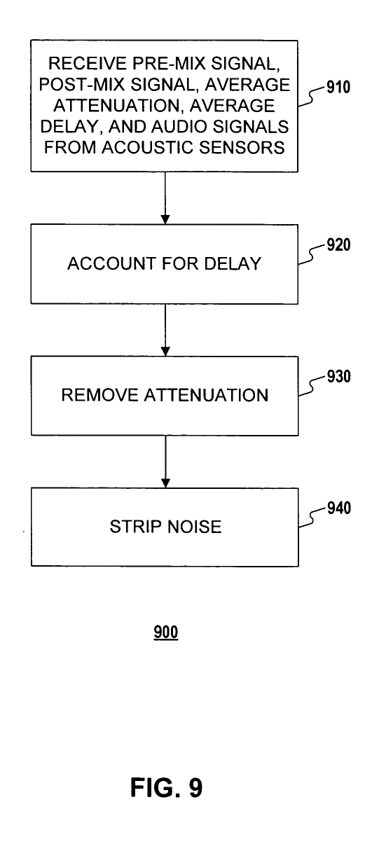

FIG. 9 illustrates a flowchart 900 of an exemplary method that may be performed by noise stripper 420 (FIG. 4) to strip noise from the audio signals from sensor array 190. At step 910, noise stripper component 420 may receive the pre-mix signal from pre-mix buffer 405, a noise-mitigation signal from a post-mix buffer which includes a signal calculated to cancel noise, the average attenuation and delay values from filter 415, and audio signals from sensor array 190.

At step 920, noise stripper component 420 may delay the pre-mix signal input to speakers 110 and 115 by an amount determined by filter 415. The noise-mitigation signal from the post-mix buffer may also be delayed. The pre-mix signal may be delayed because the distances between each of the speakers and the specified listener location are not all the same. As a result, noise stripper component 420 may delay the signal 232 supplied to speaker having the shorter distance so that the sound stream from that speaker arrives at the specified listener location at the same time as the sound stream sent from the speaker that is further away.

At step 930, the average attenuation value provided by filter 415 may be removed from the noise stream.

At step 940, filter 415 may strip noise from the signals output from sensor array 190. Step 920, step 930, and step 940 may be implemented using an algorithm. An exemplary pseudo code algorithm for steps 920, 930, and 940 may be expressed as follows:

NOISE(i, :) = SAMPLE(i, :);
for j = 1:Nstreams{

delay = sample_length − Delay_Avg(i);
NOISE(i,:) = NOISE(i,:) − ATTEN_AVG(i, J) *
(PRE_SOURCE_MIX(i, (delay + 1):(delay + sample_length)) −
POST_NOISE_MIX(i, (delay + 1):(delay + sample_length)));

where NOISE=the estimated noise; SAMPLE=the audio signal from sensor array 190; Nstreams=the number of Speakers (number of input signals to speakers 110 and 115); j=the counting index from 1 to Nstreams; delay=the amount of delay needed to be placed upon a stream; Delay_Avg=the average delay provided by filter 415; ATTEN_AVG=the average attenuation provided by filter 415; sample_length=the number of data points in sensor stream; PRE_SOURCE_MIX=the pre-source mix signal; and POST_SOURCE_MIX=the post source mix signal including the noise-mitigation.

The methods provided herein may be performed continuously, allowing the state of system 200 to be continuously updated.

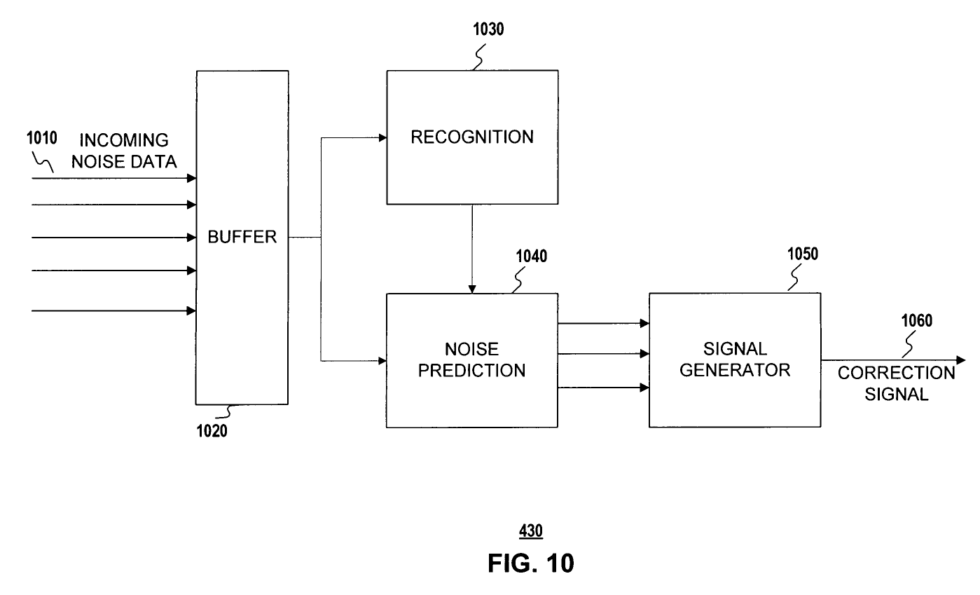

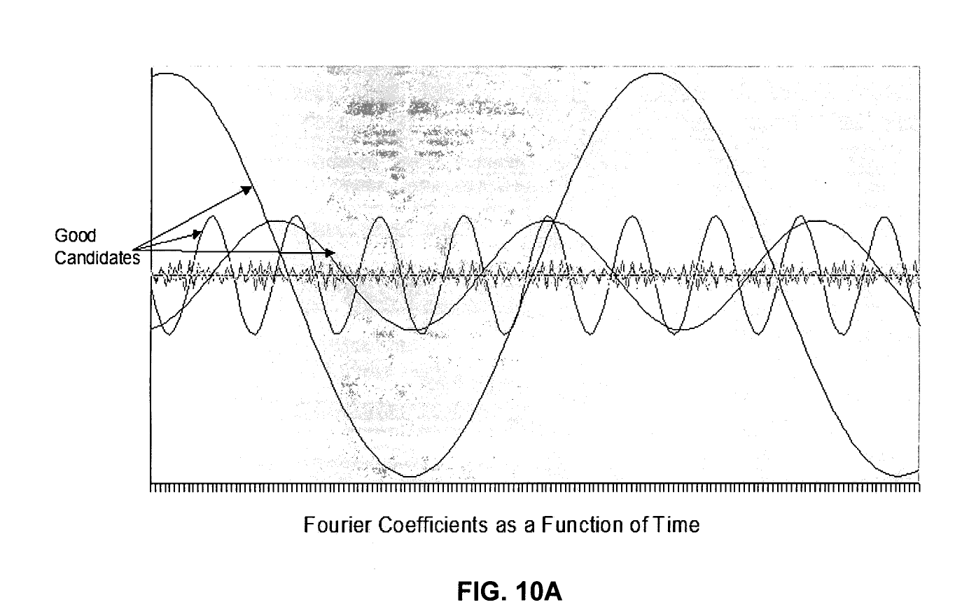

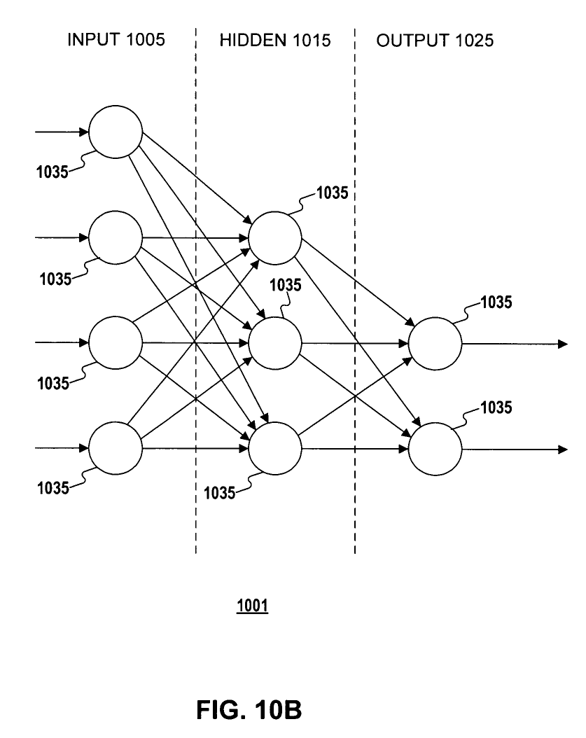

FIG. 10 illustrates an exemplary functional block diagram of a pattern recognition component 430 (FIG. 4), consistent with the invention. In particular, pattern recognition component 430 may include terminals receiving incoming noise data 1010, a buffer 1020, a recognition module 1030, a noise prediction module 1040, a signal generator 1050, and terminals outputting a noise correction signal 1060. Pattern recognition component 430 may determine an underlying noise pattern from the noise signals provided by noise stripper component 420. Pattern recognition component 430 may also predict a pattern of noise signals and return the repeatable pattern of noise signals to steering and control module 230, which may modify a mixing law to cancel the predicted noise signals. For example, pattern recognition component 430 may determine a pattern of noise caused by a group of people talking in a room. By identifying these patterns in noise, system 200 may mitigate the noise to provide the desired sound to a specified listener location in audio environment 100.

The input signals 232 to speakers 110 and 115 may constitute signals processed by a modified mixing law to produce an expected sound field at sensor array 190. Sensor array 190 may receive the expected sound field and generate expected sound signals. The expected sound field may have characteristics which vary from the desired sound field at the specified listener location due to delay and attenuation between sensor array 190 and the specified listener location. Pattern recognition component 430 may compare the actual audio signals from sensor array 190 to the expected audio signals and determine an amount of deviation between these signals. This deviation may indicate an error in the system, that additional noise sources have been introduced into audio environment 100, or that noise sources have been removed from or attenuated in audio environment 100. Pattern recognition component 430 may use this deviation to update the mixing law and measure a new deviation. Over time, pattern recognition component 430 may identify patterns of noise within audio environment 100. By identifying patterns of noise, pattern recognition component 430 may predict future noise, providing for a more accurate mixing law and less deviation.

Incoming noise data 1010 may be the resulting noise signals provided by noise stripper component 420. Incoming noise data 1010 may be a time series, with the series of inputs being treated as a queue, and may be input to buffer 1020. Incoming noise data 1010 may be provided to buffer 1020 periodically, as pattern recognition may be computational-intensive. Buffer 1020 may be queued to allow a previous state to persist through a larger number of iterations.

Recognition module 1030 may employ methods to identify patterns in incoming noise data 1010. Recognition module 1030 may consider noise data 1010 in intervals, such as one-fourth of a second. Recognition module 1030 may utilize iterative artificial intelligence methods to identify patterns in noise input 1010 and to predict future noise that will be received by sensor array 190. Recognition module 1030 may be implemented using, for example, a neural network (FIG. 10B). Additional pattern recognition methods and techniques may also be used.

Recognition module 1030 may output a score for Fourier “frequency buckets.” Scores may be assigned using the average magnitude of Fourier coefficients and using a second derivative. Higher scores may be assigned to frequency ranges having a large average magnitude of Fourier coefficients, and a low second derivative. High scores may indicate that the frequency range is a good candidate for noise prediction module 1040 to predict noise.

For example, as illustrated in FIG. 1A, several good candidates are identified which have large average magnitude of their Fourier coefficients, and low second derivative of the function describing these coefficients. In audio environment 100, these good candidates are likely to be noise streams that have a cyclical nature, such as noise streams produced by the whirl of a fan or a lawn mower. These noise streams may be identified by recognition module 1030 using artificial intelligence and assigned a high score.

Once recognition module 1030 has identified the noise streams that are likely to be predictable, noise prediction module 1040 may control the output of a cancellation signal for the characteristic frequencies of the identified noise streams. Noise prediction module 1040 may be implemented as a fuzzy logic controller. Noise prediction module 1040 may receive incoming noise data 1010 from buffer 1020, and may run continuously. Incoming noise data 1020 may be transferred to the frequency domain using a Fast Fourier Transform. Noise prediction module 1040 may use the noise signals from the previous sample group to compute a Fourier transform.

Noise prediction module 1040 may identify pattern errors, which may be defined as the difference between output of noise prediction module 1040 and the incoming noise data 1010, and may determine the magnitude of correction needed for the frequency ranges identified by recognition module 1030. Noise prediction module 1040 may receive as input the Fourier coefficient of the noise for the frequency range to be considered, the correction value that was predicted for this coefficient on the previous iteration, and the error from the previous iteration. Noise prediction module 1040 may output a new correction signal and may store the error of the current iteration for use in the next iteration.

The output of the noise cancellation signal may be classified as too low, ideal, and too high, as illustrated in the first row of Table 1 below. The pattern error may vary even if the output of the noise cancellation signal is not changed due to changes in audio environment 100. The error may be expressed as decreasing, constant, and increasing, as illustrated in the left column of table 1. Each block in table 1 may be described as a membership value.

TABLE 1

| | Output too low | Output ideal | Output too high |
|---|---|---|---|
| Error | Increase Output | Increase Output | Decrease Output |
| decreasing | | | |
| Error | Increase Output | Do Nothing | Decrease Output |
| constant | | | |
| Error | Increase Output | Decrease Output | Decrease Output |
| increasing | | | |

In operating as a fuzzy logic controller, noise prediction module 1040 may use fuzzy “ors” to return the value of the greater membership value, may use fuzzy “ands” to return the value of the lesser membership value, and may use the “root-sum-square” method to determine how much of a rule exists. These techniques may aid noise prediction module 1040 in classifying the pattern error such that the noise streams may be effectively canceled.

The output of noise prediction module 1040 may identify how much of each selected frequency bucket should be changed. Signal generator 1050 may convert the output of the frequency ranges output by noise prediction module 1040 back into time domain waves that correspond to the specified frequency-domain signal provided by noise prediction module 1040, in the form of noise correction signal 1060.

FIG. 10B illustrates a schematic diagram of a neural network 1001 for use by recognition module 1030, consistent with the invention. Neural network 1001 may receive a time series of the noise streams and may comprise a plurality of layers, with each layer having one or more nodes 1035. For example, neural network 1001 may include an input layer 1005, one or more hidden layers 1015, and an output layer 1025. The output of each node 1035 in input layer 1005 may connect to each node 1035 in hidden layer 1015, and the output of each node 1035 in the hidden layer 1015 may connect to each node in output layer 1025. Output layer 1025 may contain any number of nodes 1035, which may select which hidden layer 1015 nodes 1035 to use for output values. The output values may be the score for the noise stream as discussed above. Initially, input layer 1005 and output layer 1025 may have the same outputs before learning begins. Neural network 1001 may use sigmoid functions.

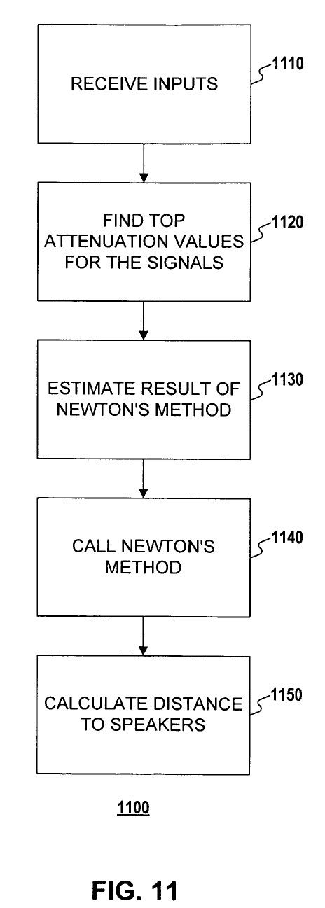

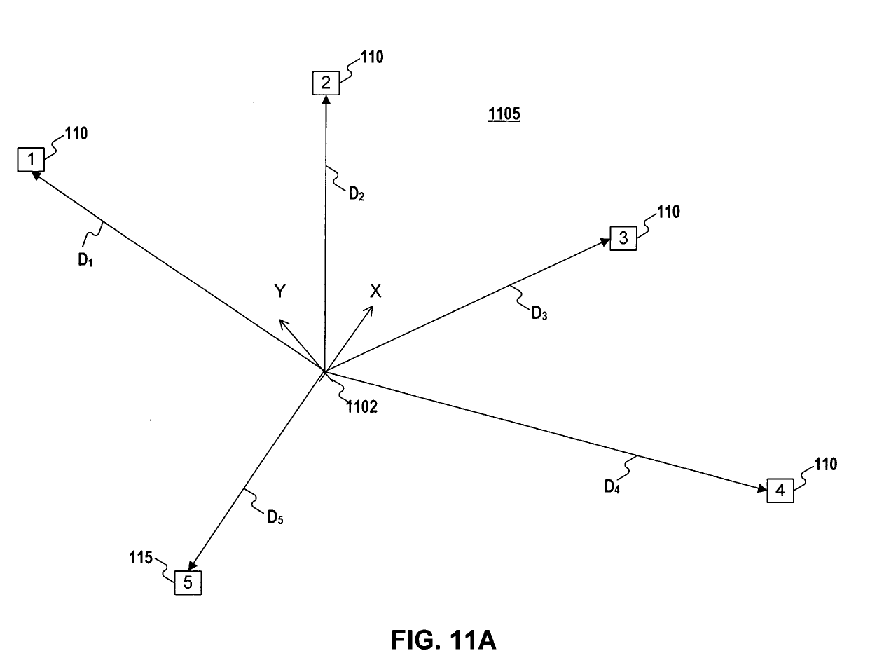

Reference will be made to both FIG. 11A and FIG. 11 to explain the method by which location component 435 determines the location of speakers 110 and 115. FIG. 11A illustrates an exemplary layout of speakers 110 and 115 in audio environment 100. FIG. 11 illustrates a flowchart 1100 of an exemplary method for determining the location of speakers 110 and 115. Location component 435 may determine a sound source coordinate frame matrix with the distance and angle of all of speakers 110 and 115 relative to the specified listener location.

FIG. 11A illustrates a layout of speakers 110 and 115, numbered 1 through 5, with the speaker numbered 1 being the center channel. The system may use the unit vector principle directions of sensor array 190 (illustrated as 1102). The principle directions of sensor array 190 may be established using the direction from one microphone to the center channel as an x axis. The locations of speakers 110 and 115 in audio environment 100 may be mapped in a sound source coordinate frame, as described in more detail below. Each speaker 110 and 115 may be located by determining a distance from the intersection of the unit vector principal directions and an angle from the x line.

Location component 435 (FIG. 4) may assume three general principles. First, location component 435 may generally assume that the attenuation from a speaker to the sensor array 190 occurs in a constant energy basis and that there is no frequency shift or frequency-specific attenuation for sounds in audio environment 100. However, in one embodiment consistent with the invention, location component 435 may account for frequency shifts and frequency specific attenuation.

Second, location component 435 may treat reflections or echoes of sound streams from speakers 110 and 115 as noise, because the reflected sound streams will have lower amplitude and will exhibit delays. Third, location component 435 will employ attenuation patterns of the microphones in sensor array 190. The attenuation patterns, or response patterns, may be received from the sensor manufacturer and supplied to the user as input into the system, or the attenuation patterns may be adaptively determined by the system.

At step 1110 (FIG. 11), location component 435 may receive inputs. The inputs to location component 435 may include the average attenuation values and average delay values determined by filter 415, values denoting the location of individual sensor array 190, and the frequency associated with the sample rate of sensor array 190, which may be provided by the manufacturer of sensor array 190.

At step 1120, location component 435 may find the highest attenuation values for the signals using autocorrelation for the samples from each microphone in sensor array 190. For example, location component 435 may find the highest two attenuations associated with each audio signal from sensor array 190. The attenuation may be calculated as (X1×M1)/(X1×X1), where X1 is a vector of the signal sent to a speaker and M1 is a vector of the output signal generated by a directional microphone. The attenuation may be calculated in this manner for each microphone and for each speaker to create a matrix of attenuation values.

Sensor array 190 may include at least three microphones, however, more may also be used. These attenuation values may then be used to determine the angles associated with the largest attenuation patterns for the corresponding microphones of sensor array 190. The sound source coordinate frame may be used to determine the angles, with the center channel speaker serving as the origin.

At step 1130, location component 435 may estimate a result using Newton's method by taking the mid-point of the angles associated with the largest two attenuation patterns for each microphone of sensor array 190. Each microphone in sensor array 190 may generate attenuation patterns, and the largest two attenuation patterns may be used for Newton's method.

At step 1140, location component 435 may call Newton's method component 440. Newton's method component may be provided as a zero-finding solver which determines the distances and attenuation. Newton's method is just one example of a zero-finding solver, additional mathematical techniques may be used.

At step 1150, location component 435 may calculate the distance from the origin of the acoustic sensor coordinate frame (the location of sensor array 190) to speakers 110 and 115. The distances are illustrated in FIG. 11A as D1, D2, D3, D4, and D5. The distance to the individual speakers may be determined from the delay observed from the speaker to sensor array 190. This delay may be measured in terms of sample periods. For example, a sample rate of 48 kHz exhibits a period between samples of about 21 microseconds. The speed of sound may be assumed to be 330 meters per second. With known values of sample rate, delay, and speed of sound, the distance between the speaker and origin may be estimated using the following equation:

$$l = speed\_of \_sound \frac{Nsamples}{frequency}$$

where l=distance, speed_of_sound=speed that an acoustic wave disturbance travels through air, Nsamples=the number of samples in a sample group, and frequency=the sample rate for the input signals to speakers 110 and 115. With the known values of angle and distance, location component 435 may dictate the locations of all speakers 110 and 115, objects, and specified listener locations in audio environment 100. Location component 435 may store the locations in an initial sound source coordinate frame matrix including the distance and angle of all the speakers relative to a specified listener location.

Newton's method component 440 (FIG. 4) may receive as inputs the attenuation characteristics of two sensor array 190, the angles of those two sensor array 190, and an initial guess. The initial guess, which may be provided from location component 435, may prevent Newton's method from converging to a local optimum (e.g., where the derivative becomes zero in a region that doesn't have the function equal to zero). Newton's method component 440 may be implemented using an algorithm. An exemplary pseudo code algorithm may be expressed as follows:

del_theta = 0.00001;
theta₁ = theta_in;
for i = 1:30{

g₁ = microphone (theta₁ − psi₁);
${dg}_{1} = \frac{[ microphone ( {theta}_{1} - {psi}_{1} + {del}_{—} theta ) - {g}_{1} ]}{{del}_{—} theta} ;$
g₂ = microphone (theta₁ − psi₂);
${dg}_{2} = \frac{[ microphone ( {theta}_{1} - {psi}_{1} + {del}_{—} theta ) - {g}_{2} ]}{{del}_{—} theta} ;$
fcn_val = [atten₁g₂ − atten₂g₁];
fcn_derivative = 2 * fcn_val * [atten₁dg₂ − atten₂dg₁];
fcn_val = fcn_val * fcn_val;
${theta}_{2} = {theta}_{1} - \frac{{fcn}_{—} val}{{fcn}_{—} derivative} ;$
if abs(theta₂ − theta₁) < 0.002

break;

end
theta₁ = theta₂;

}

where del_theta=the value added to the current theta to create a numerical derivative; theta_in =the initial guess of theta; theta₁=the current guess for theta; i=a counting index; g₁=the microphone attenuation estimate of microphone #1; microphone=The microphone attenuation estimate value (due to the directional microphone values only); psi₁=the angle, in the acoustic sensor coordinate frame (described below), that microphone #1 lies in; dg₁=the derivative of the microphone #1 attenuation at theta₁; g₂=the microphone attenuation estimate of microphone #2; dg₂=the derivative of the microphone #2 attenuation at theta₁; fcn_value=the value of the function to be optimized at theta₁; atten₁=the estimated attenuation of microphone #1; atten₂=the estimated attenuation of microphone #2; fcn_derivative=the real derivative of the function to be optimized at theta₁; and theta₂=the new estimate for theta.

Newton's method component 440 may return the estimated location of the sound source, theta, and the estimated transport attenuation. Newton's method component 440 may repeatedly execute the algorithm to generate successive values of the estimated location of the sound source and the estimated transport attenuation from the sound source to the origin, until a predetermined stopping criteria is met. That is, execution of the algorithm may be halted when the change in value of the last iteration is within a predetermined difference (for example, 0.010 (approximately 0.002 rad)) of the value derived in the previous iteration. Alternatively, the algorithm may halt when a maximum number of iterations is reached.

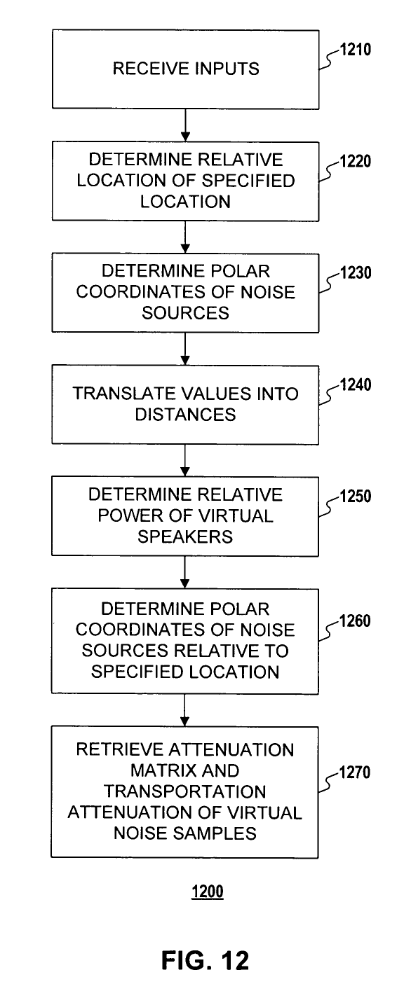

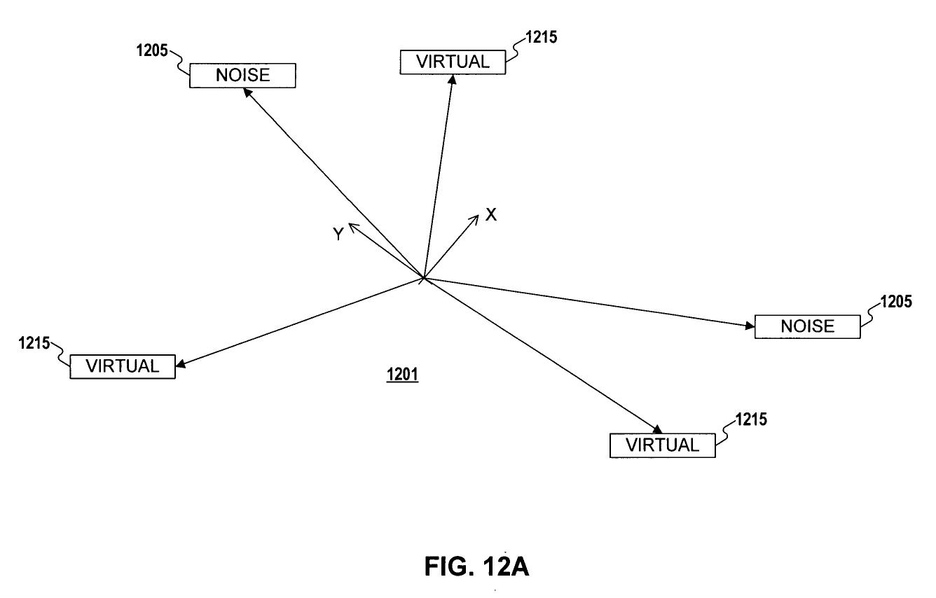

FIG. 12A illustrates an exemplary layout of actual noise sources 1205 and “virtual” noise sources 1215 in audio environment 100. A virtual noise source may be defined as a hypothetical noise source at a location determined such that the virtual noise source duplicates the properties of one or more actual noise sources in audio environment 100. Virtual noise sources are used to overcome the problem of determining how many actual noise sources exist in audio environment 100. The virtual noise sources can be canceled, which will have duplicative affect on the actual noise sources to cancel noise in audio environment 100. That is, virtual noise sources 1215 combine to form vectors having the same amplitude and direction as the vectors from actual noise sources 1205.

FIG. 12 illustrates a flowchart 1200 of an exemplary method that may be performed by noise location component 445 (FIG. 4). Noise location component 445 may determine the source of noise in audio environment 100 by creating “virtual noise sources.”

At step 1210, noise location component 445 may receive inputs, including noise vectors from pattern recognition component 430, polar coordinates of speakers 110 and 115 relative to a specified listener location, polar coordinates of speakers 110 and 115 relative to sensor array 190, and coordinate frame parameters from coordinate frame component 455 (e.g., speaker1, speaker2, distanced, and distance2 as discussed in detail below).

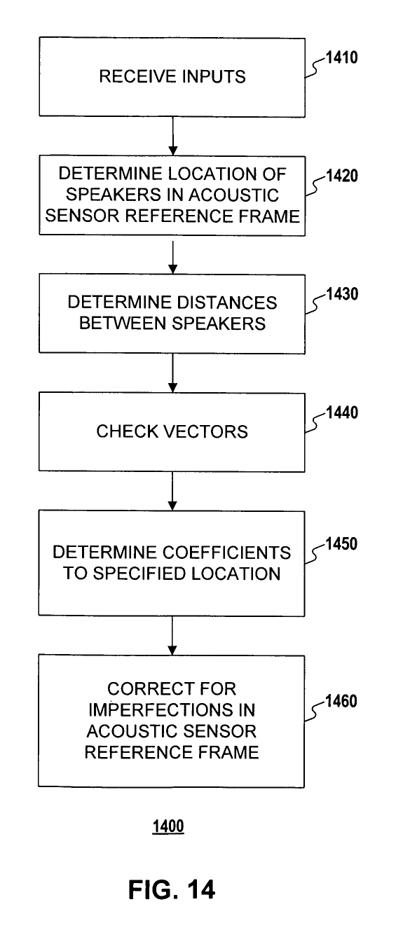

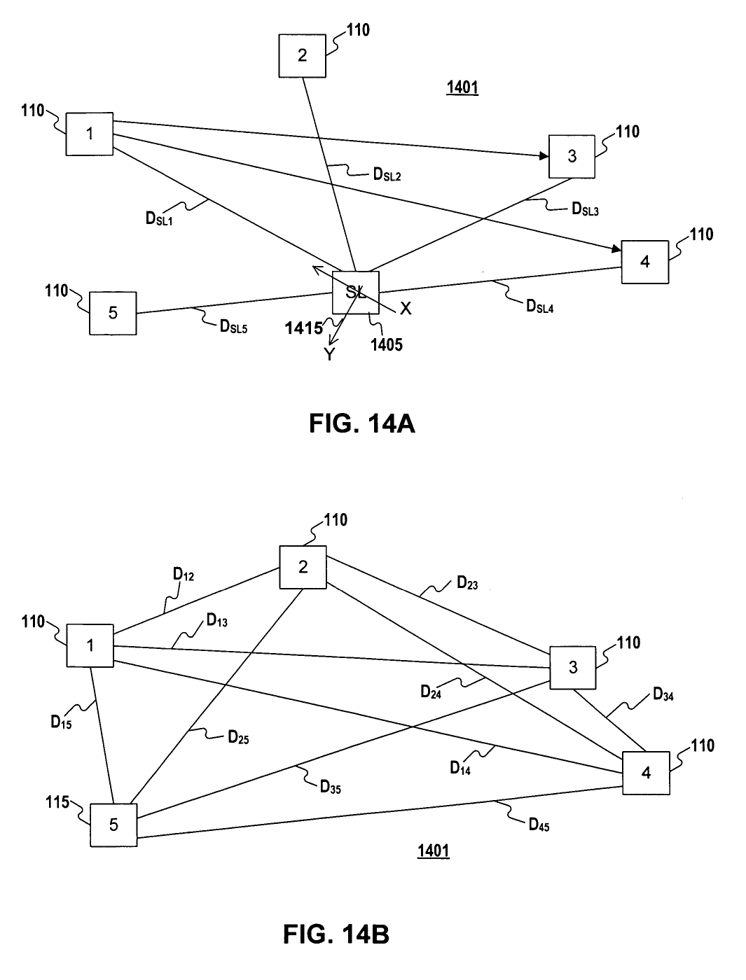

At step 1220, noise location component 445 may determine the relative location of a specified listener location to sensor array 190 using autocorrelation to provide an estimate of attenuation of a virtual noise source. Step 1220 will be described in more detail with respect to coordinate frame component 455 in FIG. 14.

At step 1230, noise location component 445 may determine the polar coordinates of the virtual noise sources relative to sensor array 190. For each noise signal, i, in the noise vector from pattern recognition component 430, noise location component 445 may identify the optimal values for alpha and theta using an algorithm. Alpha may be the attenuation due to geometric spreading, and theta may be the angle from the x axis of the acoustic sensor coordinate frame to the virtual noise source.

An exemplary pseudo code algorithm may be expressed as follows:

| temp_dot_prod[1]= dot(NOISE _VECTOR[1,:],NOISE | |
|---|---|
| _VECTOR[1,:]); | |
| for | i = 1 : Nmics{ |

| Coeffs[i]= 0; | |
|---|---|
| for | j = 1 : Nmics{ |

| | |
|---|---|
| if | i == j{ |

continue;

| } | |
|---|---|
| if | i == 1{ |

temp_dot_prod[j]=dot(NOISE
_VECTOR[j,:],NOISE _VECTOR[j,:]);

}
Coeffs[j]= dot(NOISE _VECTOR[i,:],NOISE
_VECTOR[j,:])/temp_dot_prod[j];

}
(Alpha[i],Theta[i])= conjugate_direc(Mic2Speak,Psi,Coeffs);

}

where temp_dot prod=the dot product of the noise stream with itself; Nmics=the number of microphones in an acoustic sensor; l=a counting index between 1 and Nmics; Coeffs=the coefficients sent to the conjugate direction function to minimize the function; j=the counting index between 1 and Nmics; dot=the dot product operator; Alpha=the attenuation estimate for the virtual noise location; Theta=the estimate for the angle indicating where the virtual noise location lies.

At step 1240, noise location component 445 may translate the alpha and theta values into distances using an algorithm. Noise location component 445 may first determine if the angles in the acoustic sensor coordinate frame are either 90° or 270°. An exemplary pseudo code algorithm may be expressed as follows:

| | |
|---|---|
| if | (Theta [i]== pi/2)OR (Theta [i]== 3 * pi /2){ |

| XY _Mic 2Noise [i,1] = 0; | |
|---|---|
| temp = sqrt (max_ range \hat{ }2 − XY _Mic 2Sweet [2]); | |
| y1 = XY _Mic 2Sweet [2]+ temp ; | |
| y2 = XY _Mic 2Sweet [2]− temp ; | |
| if | y1 * y2 > 0{ |

error ;

| } | |
|---|---|
| if | y1 < 0 & Theta [i]== 3 * pi/2{ |

XY _Mic 2Noise [i,2]= y1;}

elseif y2 < 0 & Theta [i]== 3 * pi/2{

XY _Mic 2Noise [i,2]= y2;}

elseif y1 > 0 & Theta [i]== pi/2{

XY _Mic 2Noise [i,2]= y1;}

else

XY _Mic 2Noise [i,2]= y2;}

}

where Alpha=the attenuation estimate for the virtual noise location; Theta=the estimate for the angle indicated where the virtual noise location lies from the x axis of the acoustic sensor coordinate frame to the virtual noise source; pi π−3.14159 . . . ; XY_Mic2Noise=the Cartesian coordinates of the virtual noise location as seen in the acoustic sensor coordinate frame; temp=a temporary variable; max range=the maximum distance to the virtual noise locations as seen in the acoustic sensor coordinate frame; XY_Mic2Sweet=the Cartesian coordinates of the specified listening location as seen in the acoustic sensor coordinate frame; y1=the positive option for the location of the noise; and y2=the negative option for the location of the noise. The exemplary pseudo code algorithm may also include:

| tantheta = tan(Theta[i]); | |
|---|---|
| costheta = cos(Theta[i]); | |
| sintheta = sin(Theta[i]); | |
| a = tantheta\hat{ }2 + 1; | |
| b = 2*(XY _Mic2Sweet[1]−tantheta* XY _Mic2Sweet[2]) | |
| c = XY _Mic2Sweet[2]\hat{ }2−XY _Mic2Sweet[1]\hat{ }2−max_range\hat{ }2; | |
| sqrt_val = sqrt(b\hat{ }2 − 4 * a * c); | |
| if | sqrt_val == NAN{ |

error;

| } | |
|---|---|
| x1 = (sqrt_val − b)/(2 * a); | |
| x2 = −(sqrt_val + b)/(2 * a); | |
| y1 = tantheta* x1; | |
| y2 = tantheta* x2; | |
| dot = costheta* x1+sintheta* y1; | |
| if | dot > 0{ |

XY _Mic2Noise[i,1]= x1;
XY _Mic2Noise[i,2]= y1;}

else{

XY _Mic2Noise[i,1]= x2;
XY _Mic2Noise[i,2]= y2;}

where tantheta=the tangent of Theta; costheta=the cosine of Theta; sintheta=the sine of Theta; a=the value “a” in y=ax²+bx+c to solve the equation by the quadratic equation:

$$x = \frac{- b \pm \sqrt{{b}^{2} - 4 ac}}{2 a} ;$$

sqrt_val=the square root value used to determine if there is a NaN issue; x1=the first guess for “x”; x2=the second guess for “x”; y1=the first guess for “y” (associated with x1); y2=the second guess for “y” (associated with x2); and dot=the dot product.

At step 1250, noise location component 445 may determine the relative power(zeta) of speakers 110 and 115. This may be accomplished, for example, as follows:
Zeta[i]=Alpha[i]*(XY_{—}Mic2Noise[i,1]ˆ2+XY_{—}Mic2Noise[i,2]ˆ2);

At step 1260, noise location component 445 may determine the polar coordinates of virtual noise sources relative to a specified listener location using the sound source coordinate frame. The virtual noise sources may duplicate the properties of one or more actual noise sources in audio environment 100. In this example, the angle may be modified such that the center channel line is zero, and all other vectors may be counted from the center channel line. Noise location component 445 may determine the polar coordinates using an algorithm.

An exemplary pseudo code algorithm may be expressed as follows:

XY _Sweet2Noise = XY _Mic2Noise − XY _Mic2Sweet;
Sweet2Noise = polar2XY(XY _Sweet2Noise);
XY _Sweet2Center = XY _Mic2Speak[1,:]− XY _Mic2Sweet;
Sweet2Center = XY2Polar(Sweet2Center);
Sweet2Noise[:,2]= Sweet2Noise[:,2]− Sweet2Center[2];
Alpha_Est[i]= Zeta[i]/Sweet2Noise[i,1];

where Sweet2Noise=the polar coordinates of the noise as seen in the listener coordinate frame; Sweet2Center=the polar coordinates of the base speaker (the speaker which is used to reference the location of the other speakers from, e.g., center channel) as seen in the listener coordinate frame; XY_Sweet2Center=the Cartesian coordinates of the base speaker (e.g., center channel) as seen in the listener coordinate frame; polar2XY=a function taking polar coordinates and changing it to Cartesian; XY2polar=a function taking Cartesian coordinates and changing it to polar coordinates; Zeta=the noise power variable; and Alpha_Est=the estimated attenuation of the noise power.

At step 1270, noise location component 445 may calculate, using sonic estimation component 465, the attenuation matrix and the transportation attenuation of the virtual noise sources from their virtual locations to the specified listener location. Noise location component 445 may perform step 1270 by, for example, calling sonic estimation component 465 as follows:
VIRTUAL_ATTEN=room_estimation(Sweet2Noise, Alpha—Est);

Noise location component 445 may output the location of noise sources in audio environment 100 in polar coordinates, the attenuation from each noise source in audio environment 100 to sensor array 190, and the mixing matrix from the virtual speakers to idealized speaker locations. Mixing matrix may be a table in the system that identifies how to mix combine signals together. The table may have columns identifying the input signals, and the rows may identify the output signals. Each output signal may be the sum of each input signal added to the corresponding entry in the table.

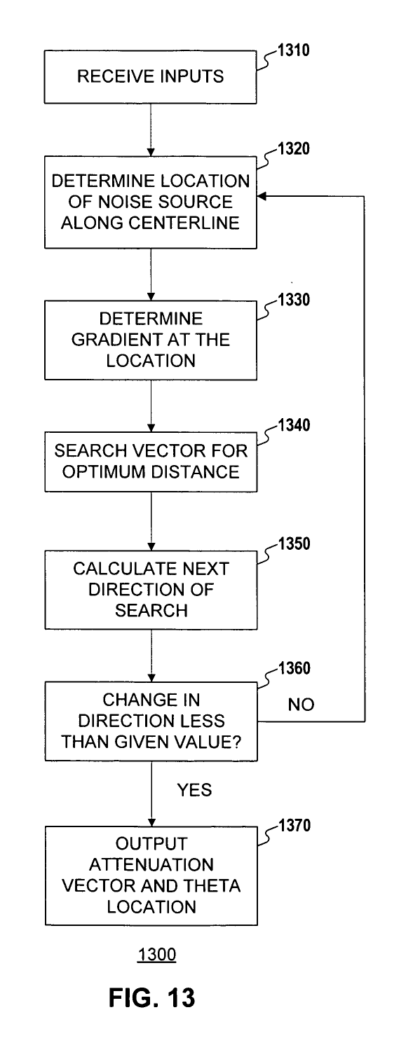

FIG. 13 illustrates a flowchart 1300 of an exemplary method that may be performed by conjugate method component 450 (FIG. 4). Conjugate method component 450 may determine the virtual locations of noise sources by solving a series of attenuation and distance ranges using properties of microphones, and by using autocorrelation.

At step 1310, conjugate method component 450 may receive noise vectors from pattern recognition component 430. Conjugate method component 450 may be a mathematical technique that solves for the most likely distance and direction of a sound. Because the true number of sound sources may not known by system 200, virtual noise systems may be created. One virtual noise source may be crated for each microphone in sensor array 190. Because the responses for the microphones are known, the virtual noise sources may be located in order to provide the same response at the microphone. The noise sources may be detected by more than one microphone, which is referred to as cross-over. By determining the amount of crossover for the microphones, the locations of virtual noise sources may be specified.

At step 1320, conjugate method component 450 may determine the location of a virtual noise source along a centerline, which may be a line from the specified listener location to the center channel speaker. The centerline may be the centerline of an sensor array 190. Conjugate method component 450 may also estimate that the transport attenuation is 1. In another embodiment consistent with the invention, conjugate method component 450 may determine an actual location of a noise source using a plurality of sensor arrays 190.

At step 1330, conjugate method component 450 may determine the gradient at the location found in step 1320 using an algorithm. An exemplary pseudo code algorithm may be expressed as follows:

del_thet = 0.00001;
del_atten = 0.0001;
f = function(theta,atten);
del_f(1) = (function(theta+del_thet,atten)−f)/del_thet;
del_f(2) = (function(theta,atten+del_atten)−f)/del_atten;
a = del_f(1)* del_f(1)+del_f(2)* del_f(2);

where del_thet=the value added to theta to get the numerical derivative; del_atten=the value added to the attenuation to get the numerical derivative; f=the function value for f(theta,atten); del_f=the gradient of f; and a=\vec{∇}f².

At step 1340, conjugate method component 450 may search along the vector determined in step 1330 to get the optimal distance using an algorithm. This process may include calling Newton's method component 440. An exemplary pseudo code algorithm may be expressed as follows:

| Search = −del_f; | |
|---|---|
| astar = newton(Search,theta,atten,2); | |
| if | astar ≈ 0{ |

return

}
theta = theta+del_f(1)* astar;
atten = atten+del_f(2)* astar;

where Search=the current search direction; and astar=the distance traveled along the Search direction.

Newton's method component 440 may be utilized, for example, to solve line optimization using an algorithm and a numerical derivative. First, the algorithm may use the gradient in an optimization function. An exemplary optimization function may be expressed as follows:

$${F}^{′} ( {θ}_{i} , {η}_{i} , α ) = {\sum }_{{j = 1}_{j \neq l}}^{Nmics} {[ ( {η}_{i} + \frac{\partial F}{\partial {η}_{i}} α ) f ( {θ}_{i} + \frac{\partial F}{\partial θ} α - {ψ}_{j} ) - \frac{{\vec{X}}_{i}^{′} \cdot {\vec{X}}_{j}^{′}}{{\vec{X}}_{i}^{′} \cdot {\vec{X}}_{i}^{′}} ]}^{2}$$

where:
θ=the angle of the virtual noise source;
η=the attenuation of the virtual noise source;
α=the direction traveled along the gradient;
ψ=the angle for the location of a microphone within specific sensor array 190; and
χ=the noise stream.

At step 1350, conjugate method component 450 may calculate the next direction of search using an algorithm. An exemplary pseudo code algorithm may be expressed as follows:

| f = function(theta,atten); | |
|---|---|
| del_f(1) = (function(theta+del_thet,atten)−f)/del_thet; | |
| del_f(2) = (function(theta,atten+del_atten)−f)/del_atten; | |
| b = del_f(1)* del_f(1)+del_f(2)* del_f(2); | |
| beta = b/a; | |
| Search = −del_f+beta* Search; | |
| a = b; | |
| Slope = Search(1)* del_f(1)+Search(2)* del_f(2); | |
| if | Slope ≧ 0{ |

start_over

}

where b=the new \vec{∇}f²; beta=the conjugate function factor

$$\frac{b}{a} ;$$

Slope determines if the search direction is in an improving direction; f_new=the updated function value; and f_old=the previous function value.

At step 1360, conjugate method component 450 may determine if the change in direction is less than a given value using an algorithm. The given value may be a solution when a change in the function f is “small,” such as less than 0.0001. An exemplary pseudo code algorithm may be expressed as follows:

| | |
|---|---|
| if | abs(f_new−f_old)<0.0001{ |

return

}

If the change in direction is not less than the given value, control may return to step 1320 for further processing. If the change in direction is less than the given value, at step 1370 conjugate method component 450 may output an attenuation vector and a theta location.

Then, the Newton's method component 450 may calculate a derivative using an algorithm. An exemplary pseudo code algorithm may be expressed as follows:

del_alpha = 0.00001;
alpha₁ = 0;
for j = 1:30{

eff1 = function(theta + del_f(1) * alpha,atten + del_f(2) * alpha);
eff2 = function(theta + del_f(1) * (alpha + del_alpha),atten + del_f(2) * (alpha + del_alpha));
fcn_derivative = (eff2 − eff1)/del_alpha;
${alpha}_{2} = {alpha}_{1} - \frac{eff 1}{{fcn}_{—} derivative} ;$
if abs(alpha₂ − alpha₁) < 0.0001

break;

end
alpha₁ = alpha₂;

}
return(alpha2);

where eff1=function value 1; eff2=function value 2; fcn_derivative=the numerical derivative from eff1 and eff2; alpha1=the previous estimate of alpha; and alpha2=the latest estimate of alpha.

Reference will now be made to FIGS. 14A, 14B, and 14 to explain coordinate frame component 455. FIG. 14A illustrates an exemplary arrangement of speakers 110 and 115 and a specified listener location in audio environment 100. FIG. 14B illustrates the arrangement of speakers 110 and 115 illustrated in FIG. 14A and the distances between each speaker. FIG. 14 illustrates a flowchart 1400 of an exemplary method that may be performed by coordinate frame component 455 (FIG. 4).

FIG. 14A illustrates an exemplary arrangement 1401 of five speakers 110 and 115, labeled 1-5, and a specified listener location 1405. The arrangement 1401 may be chosen by the listener depending on the size, shape, and layout of audio environment 100 and the encoding method of signals provided by A/V source 355 (FIG. 3A). The specified listener location 1405 may be a listening location chosen by the user, such as a favorite chair. Coordinate frame component 455 may create a listener coordinate frame around the specified listening location 1405 in audio environment 100. As described below, coordinate frame component 455 may create the listener coordinate frame origin 1415 at the specified location.

FIG. 14B illustrates the distances between each of the speakers 110 and 115 labeled one through five. The distance between each speaker is labeled D, with a subscript indicating the two speakers between which the distance is measured. For example, D₁₂ indicates the distance between speaker 110 labeled one and speaker 110 labeled 2.

A sound source coordinate frame may be created using, for example, three of speakers 110 and 115. A first speaker may be chosen as a reference point, which may be the center channel speaker in a home theater system. For example, assume that speaker 110 labeled 1 is the center channel speaker. Coordinate frame component 455 may choose the two additional speakers that are furthest apart, and which are not co-linear with center channel speaker 1. As illustrated in FIG. 14B, D₅₄ is the longest distance, meaning speakers 110 labeled 5 and 4 are the furthest apart. Coordinate frame component 455 may choose the speaker vectors that run along the line of D₁₄ and D₁₅ as the reference axis for the sound source coordinate frame. Coordinate frame component 455 may ensure that these resulting speaker vectors from speaker 110 labeled 1 (the center channel and reference point) to speakers 110 labeled 5 and 4 are both non-zero and non-parallel vectors. The remaining items in audio environment 100 may be located by the distance from speaker 1, and the angle from the vectors along D₁₅ and D₁₄.

FIG. 14 illustrates a flowchart 1400 of an exemplary method that may be performed by coordinate frame component 455 (FIG. 4). At step 1410, coordinate frame component 455 may receive inputs, including an initial sound source coordinate frame matrix with the distance and angle of all the speakers relative to specified listener location 1405. Coordinate frame component 455 may receive the initial sound source coordinate frame matrix from location component 435. Coordinate frame component may be run at initialization when sensor array 190 are located at the specified location.

At step 1420, coordinate frame component 455 may determine the location of speakers in the coordinate frame using an algorithm. An exemplary pseudo code algorithm may be expressed as follows:

for i = 1 : Nspeaker s{

Speaker_XY(i,1)= INITIAL_SPEAKER_FRAME(i,1)*cos(INITIAL_SPEAKER_FRAME(i,2));
Speaker_XY(i,2)= INITIAL_SPEAKER_FRAME(i,1)*sin(INITIAL_SPEAKER_FRAME(i,2));

}

where NSpeakers=the number of speakers 110 and 115 in the system; Speaker_XY=the physical location of speakers in Cartesian coordinate frame; and INITIAL_SPEAKER_FRAME=the speaker locations in polar coordinates.

At step 1430, coordinate frame component 455 may determine the distances between speakers 110 and 115 using an algorithm. The algorithm may find the largest distance between any two speakers 110 and 115 in audio environment 100. A first speaker, such as a center channel, may be used as a reference point, as described above with reference to speaker 110 labeled 1 (FIG. 14B). An exemplary pseudo code algorithm may be expressed as follows:

| | |
|---|---|
| for | i = 2 : (Nspeaker s − 1){ |

| | |
|---|---|
| for | j = (i + 1) : Nspeaker s{ |

| distance = [Speaker_XY(i,1)−Speaker_XY(j,1)]² +[Speaker_XY(i,2)−Speaker_XY(j,2)]²; | |
|---|---|
| if | distance > largest |

largest = distance;
Speaker s = [i,j];

endif

}

}

where Nspeakers=the number of speakers 110 and 115 in audio environment 100; distance=a distance between any two speakers 110 and 115; largest=the largest distance between any two speakers 110 and 115; and Speakers=the speakers used in the value largest.

At step 1440, coordinate frame component 455 may execute an algorithm to check the vectors from speaker 110 labeled 1 (reference point, FIG. 14B) to the two speakers that are furthest apart (speakers 110 labeled 5 and 4, FIG. 14B) to ensure that these speaker vectors are usable. To be usable, the vectors must be non-zero and non-parallel. If the vectors are not usable, the two speakers that are second farthest apart may be used, and so on until a usable set is found. An exemplary pseudo code algorithm may be expressed as follows:

Vector1(1) = [Speaker s_XY(Speaker s(1),1)−Speaker s_XY(1,1)];
Vector1(2) = [Speaker s_XY(Speaker s(1),2)−Speaker s_XY(1,2)];
Vector2(1) = [Speaker s_XY(Speaker s(2),1)−Speaker s_XY(1,1)];
Vector2(2) = [Speaker s_XY(Speaker s(2),2)−Speaker s_XY(1,2)];
dotproduct = Vector1(1)* Vector2(1)+ Vector1(2)* Vector2(2);
magnitude1 = \sqrt{Vector1(1)* Vector1(1)+ Vector1(2)Vector1(2)};
magnitude2 = \sqrt{Vector2(1)* Vector2(1)+ Vector2(2)Vector2(2)};

| | |
|---|---|
| if | abs(dotproduct − magnitude1 * magnitude2) ≦ eps |

Bannedlist = Speaker s;

endif

where Vector1=the first vector used for the first principle direction creating the sound source coordinate frame; Vector2=the second vector used for the second principle direction creating the sound source coordinate frame; dotproduct=the dot product of Vector1 and Vector2; magnitude1=the magnitude of Vector1; magnitude2=the magnitude of Vector2; and Bannedlist=the list of speaker combinations that are co-linear.

At step 1450, coordinate frame component 455 may execute an algorithm to determine the distance and angles to the specified listener location. The distances may be measured from the origin of the sound source coordinate frame. The algorithm may utilize Cramer's rule. An exemplary pseudo code algorithm may be expressed as follows:

vector_det er minat = Vector1(1)* Vector2(2)− Vector1(2)Vector2(1);
distance1 = (− Speaker s_XY(1,1)* Vector2(2)+ Speaker s_XY(1,2)*
Vector1(2));
distance2 = (− Speaker s_XY(1,2)* Vector1(1)+ Speaker s_XY(1,1)*
Vector2(1));

where vector_determinant=the determinant of the vectors Vector1 and Vector2; distance1=the distance to a speaker along Vector1; and distance2=the distance to a speaker along Vector2.

At step 1460, coordinate frame component 455 may correct for imperfections in the acoustic sensor coordinate frame. For example, the x axis of the acoustic sensor coordinate frame may not line up exactly with the line from sensor array 190 to the center channel speaker. Accordingly, coordinate frame component 455 may assume that the line from the specified listener location to the center channel speaker corresponds to the polar coordinate of theta=zero. Coordinate frame component 455 may determine which of speakers 110 and 115 is the center channel (e.g., through an input variable). Next, coordinate frame component 455 may subtract from the angles the amount of the angle that the x axis of the acoustic sensor coordinate frame was off from the line from sensor array 190 to the center channel speaker. Coordinate frame component 455 may then ensure that the angles for each speaker is between zero and 2π by executing an algorithm. An exemplary pseudo code algorithm may be expressed as follows:

| | |
|---|---|
| for | i = 1 : Nspeaker s{ |

Sweet_Polar(i,1) = INITIAL_SPEAKER_FRAME(i,1);
Sweet_Polar(i,2) = mod(INITIAL_SPEAKER_FRAME(i,2)−
INITIAL_SPEAKER_FRAME(1,2),2 * pi);

}

where Sweet_Polar=the location of the listener location in polar coordinates.

Coordinate frame component 455 may return five variables: distance1, distance 2, speaker 1, speaker 2, and specified_polar. The distances are the distances from the center channel to the two speakers that are farthest apart, the speakers are the two speakers that are farthest apart, and specified_polar may be a matrix with the coordinates of the specified listener location to each of the speakers. The distances may be measured, for example, in meters.

Coordinate frame component 455 may be run when the system is first initialized, or when the listener wishes to move the location of speakers 110 and 115. Coordinate frame component 455 may also be run when the listener wishes to move his “sweet spot,” or to move the specified listener location at which to create the desired sound field.

Angles component 460 may return the desired angles between speakers 110 and 115 based on the number of speakers in audio environment 100, as described below.

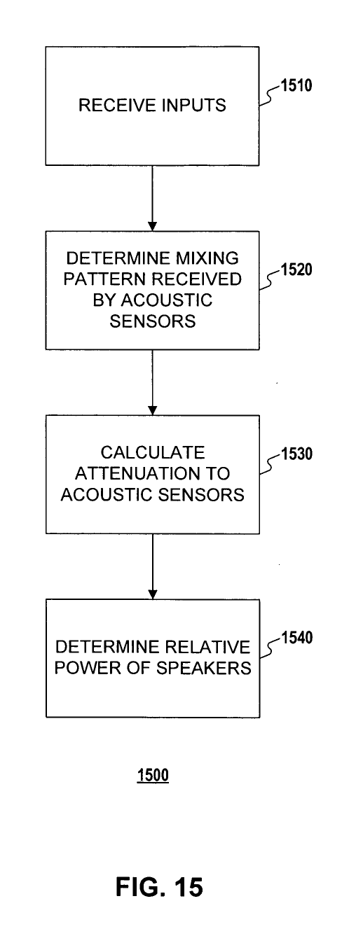

FIG. 15 illustrates a flowchart 1500 of an exemplary method that may be executed by sonic estimation component 465 (FIG. 4). Speakers 110 and 115 may not be positioned in an ideal manner within acoustic environment. Sonic estimation component 465 may utilize the results from coordinate frame component 455, the details of the location of speakers 110 and 115, and the specified listener location from location component 435 to determine the sound field properties of acoustic environment 100 at the specified listener location.

At step 1510, sonic estimation component 465 may receive inputs, including the polar coordinates of speakers 110 and 115 relative to the specified listener location from location component 435 (POL_SWEET_TO_SPEAKER), the attenuation from speakers 110 and 115 to the specified listener location from filter 415 (SPEAKER_ATTEN), and the ideal placement of speakers 110 and 115 from angles component 460 (ideal_Theta).

At step 1520, sonic estimation component 465 may determine the mixing pattern received by sensor array 190. The mixing pattern may be determined by calculating, for each speaker, which two “ideal” speakers straddle the real speaker location.

At step 1530, sonic estimation component 465 may calculate the attenuation between speakers 110 and 115 and sensor array 190 by executing an algorithm. An exemplary pseudo code algorithm may be expressed as follows:

atten(:,j) = 0;
temp = 1−(POL_SWEET_TO_SPEAKER[j,1]− theta1)/(theta2 −
theta1);
ATTEN_SENSED(loc_theta1,j) = SPEAKER_ATTEN(j)* (1 − temp);
ATTEN_SENSED(loc_theta2,j) = SPEAKER_ATTEN(j)* temp;

where atten=the attenuation value; ATTEN_SENSED=the attenuation sensed at the listener's location; and SPEAKER_ATTEN=the attenuation of the virtual noise speaker sensed at the acoustic sensors.

At step 1540, sonic estimation component 465 may determine the relative power, zeta, of speakers 110 and 115 by executing an algorithm. An exemplary pseudo code algorithm may be expressed as follows:

Zeta(j) = SPEAKER_ATTEN(j)* POL_SWEET_TO_SPEAKER(j,2)\hat{ }2;

where Zeta=the power of the noise speaker and POL_SWEET TO_SPEAKER=polar coordinates of the speakers as seen in the listener coordinate frame.

Sonic estimation component 465 may output the attenuation sensed at the specified listener location (ATTENUATION_SENSED) and the relative power of each speaker (Zeta).

Guidance Module 220

Once navigation module 210 has determined the layout and acoustic profile of audio environment 100, guidance module 220 (FIG. 2) may define a desired sound field at a specified listener location in audio environment 100, taking into account the layout and acoustic profile determined by navigation module 210. The processes of guidance module 220 may be performed during initialization when a user holds sensor array 190 at the specified listener location in audio environment 100.

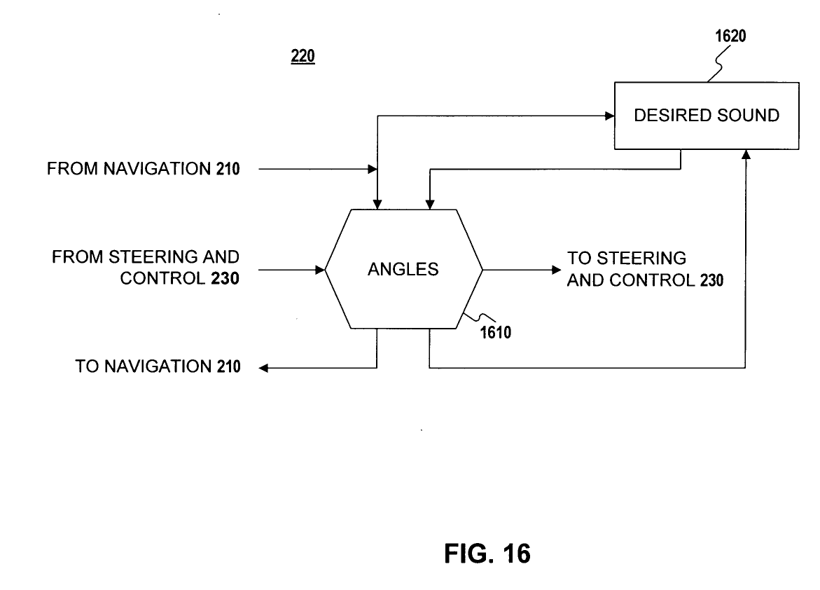

FIG. 16 illustrates an exemplary functional block diagram of guidance module 220, consistent with the invention. Guidance module 220 may receive inputs from navigation module 210 and steering and control module 230. Guidance module 220 may provide outputs to navigation module 210 and to steering and control module 230.

Angles module 1610 may determine the optimum positions of speakers 110 and 115 around a specified listening location. These optimum positions will likely differ from the actual locations of speakers 110 and 115 in audio environment 100. Manufacturers may provide the optimum positions of speakers 110 and 115 to reproduce audio programming, as set forth by audio standards such as Dolby Digital 5.1, Dolby Pro Logic II, Dolby Digital EX, and DTS ES.

Angles module 1610 may receive the number of speakers 110 and 115 as a variable at startup and determine the optimum location of speakers 110 and 115. Alternatively, angles module 1610 may actively detect the number of speakers 110 and 115, for example, by sending a test signal through the output to a speaker 110 and 115, and determining if a sound stream is generated by the tested speaker. If sensor array 190 do not detect a sound stream for the tested speaker, then that speaker either is not connected or is not operating. Once the number of speakers is determined, angles module 1610 may return the optimum positions of speakers 110 and 115, for example, by using table 1. Speakers 110 and 115 need not be actually located in these optimum positions. Rather, system 200 may balance the sound streams generated by speakers 110 and 115 such that the sound streams sound like they are coming from the optimum positions.

TABLE 1
Audio output location look-up table

| Num Input | Location 1 | Location 2 | Location 3 | Location 4 | Location 5 | Location 6 | Location 7 |
|---|---|---|---|---|---|---|---|
| 4 | 0 | π/4 | π | 7π/4 | — | — | — |
| 5 | 0 | π/6 | 11π/18 | 25π/18 | 11π/6 | — | — |
| 6 | 0 | π/6 | 11π/18 | π | 25π/18 | 11π/6 | — |
| 7 | 0 | π/6 | π/2 | 5π/6 | 7π/6 | 3π/2 | 11π/6 |

Each microphone within sensor array 190 may be positioned at an angle equal to 360 degrees divided by the number of sensor array 190. The optimum arrangement of microphones in sensor array 190 may be determined by an algorithm. This process may be performed prior to providing a user with system 200. An exemplary pseudo code algorithm may be expressed as follows:

Sensor_Location(1) = 0;
for i =2 2 : NSensors{
${Sensor}_{—} Locations ( i ) = {Sensor}_{—} Locations ( i - 1 ) + \frac{2 π}{Nsensors} ; \}$

where Sensor_Locations=the angles in the acoustic sensor coordinate frame that locate each individual microphone.

Desired sound component 1620 may determine how many sound streams, i.e., the number of speakers, exist in audio environment 100. Desired sound component 1620 may use the number of sound streams to define a desired sound field at a specified listener location in audio environment 100. The desired sound field may be an equal weighting from each speaker coming only from the optimum position determined by angles module 1610 for the corresponding speaker. The desired sound field may exclude noises in audio environment 100.

Speakers 110 and 115 may have varying size, efficiency, power handling capability, and distance to the specified listener location. Each speaker 110 and speaker 115 may also have a transport attenuation as discussed above. To account for these variations, desired sound component 1620 may ensure that the amplitude of sound produced by each speaker matches that of the speaker having the lowest amplitude. Desired sound component 1620 may also raise the amplitude of each speaker to a level that matches the highest amplitude, however, this may result in distortion of sounds produced by speakers exceeding their linear transducer capability.

Desired sound component 1620 may receive the transport attenuation vector for each speaker 110 and speaker 115, and return the minimum attenuation as an ideal mix. Transport attenuation vector may be a matrix having a size of M×N, with M representing the number of rows and N representing the number of columns.

Steering and Control Module 230

Steering and control module 230 (FIG. 2) may be provided by a separate steering component and a control component. The steering component may determine how to create the desired sound field determined by guidance module 220 in the audio environment mapped by navigation module 210. The steering component may create the mixing pattern necessary to correct for the determined imperfections in audio environment 100. The control component may physically implement the results of the steering section.

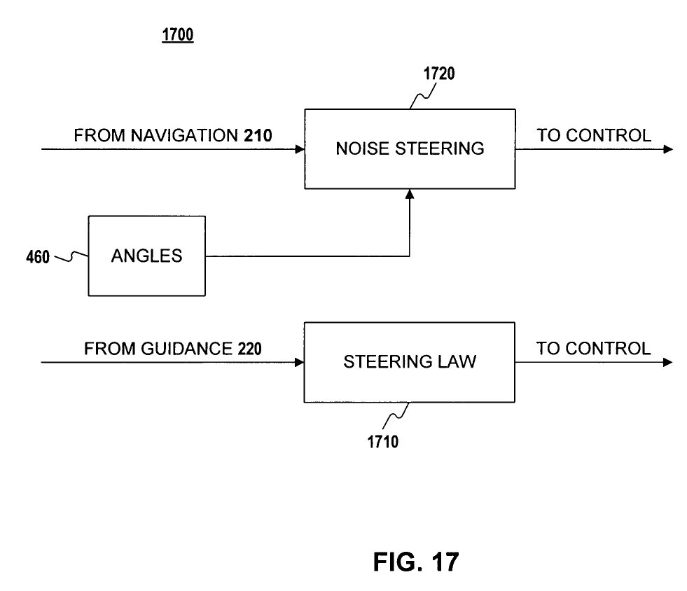

FIG. 17 illustrates an exemplary functional block diagram of a steering component 1700, consistent with the invention. The steering component may receive inputs from navigation module 210, angles component 460 (FIG. 4), and guidance module 220, and return outputs to the control component. The steering component may be run in real-time, to constantly create updated mixing patterns needed to provide a desired sound to a specified listener location in audio environment 100.

A steering law component 1710 may identify a desired sound field at a specified listener location, such as the location of a listener. This process may be represented as
S̅″=R*C* S̅,
where S̅″̅ represents the desired signal, S̅ represents a set of input signals (for example, pulse code modulation signals) to speakers 110 and 115, R represents the slow correction matrix determined by pattern recognition component 430, and C represents a linear transform. Pulse code modulation signals may be generated by sensor array 190, by PC 305, or by DSP 345. Sound streams provided to speakers 110 and 115 may be analog, or the sound streams may be digital and a digital to analog converter may be provided within speakers 110 and 115. Steering law component 1710 may determine C such that the desired signal is identical to or closely correlated to the signals input to speakers 110 and 115, for transmission as sound streams in audio environment 100.

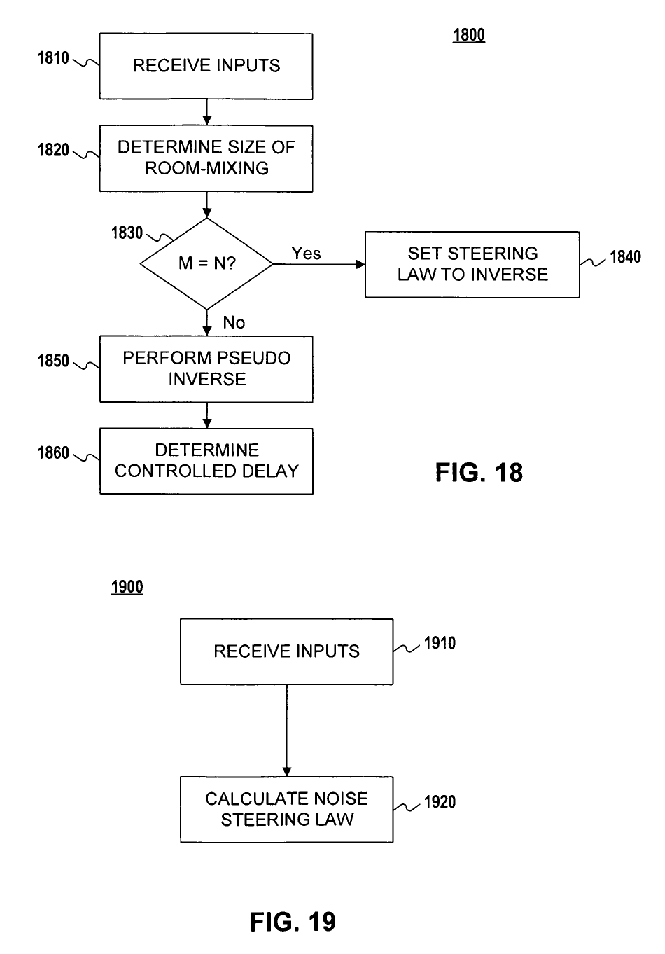

FIG. 18 illustrates a flowchart 1800 of an exemplary method performed by steering component 1100. At step 1810, steering law component 1710 may receive inputs, including the estimated room acoustic dynamics at the specified listener location, ROOM_MIXING, from sonic estimation component 465 (FIG. 4) and the real delay from speakers 110 and 115 to the specified listener location from linear filter 415 (FIG. 4).

At step 1820, steering law component 1710 may determine the size of the ROOM_MIXING matrix by counting the number of rows, M, by the number of columns, N.

At step 1830, steering law component 1710 may determine if M is equal to N. If M is equal to N, at step 1840 the steering law may be set equal to the matrix inverse of ROOM_MIXING.

If M does not equal N, at step 1850 steering law component 1710 may perform a pseudo inverse of ROOM_MIXING by executing an algorithm. Steering law component 1710 may use three routines to perform the pseudo inverse: mat_inverse, which returns an inverse of the matrix, mat_mult, which multiples two matrices, and mat_transpose, which returns a transpose of the matrix. An exemplary pseudo code algorithm for performing the pseudo inverse may be expressed as follows:

ROOM_TRANSPOSE = mat_transpose(ROOM_MIXING);
MULT_VAL = mat_mult(ROOM_TRANSPOSE,ROOM_MIXING);
FIRST = mat_inverse(MULT_VAL);
STEERING_LAW = mat_mult(FIRST,ROOM_TRANSPOSE);

where:
ROOM_TRANSPOSE=the matrix transpose of ROOM_MIXING;
MULT_VAL=the matrix multiplication of ROOM_TRANSPOSE and ROOM_MIXING;
FIRST=a matrix that is the inverse of MULT_VAL; and
STEERING_LAW=the pseudo inverse of ROOM_MIXING.

Steering 170 may also perform error handling, such as checking to see if an entire row becomes zero during the row reduction. If an entire row does become zero, steering 170 may abort and return the identity matrix. For example, if a user is watching a movie, the movie may go completely silent during a tense moment. In this situation, speakers 110 and 115 may not generate any sound streams, and so only noise may be received. However, because there is no sound being generated by speakers 110 and 115, everything may be ignored and an identity matrix may be returned. Once the mixing law may be estimated again because sound streams are generated by speakers 110 and 115, steering 170 may abort the error handling.

At step 1860, steering law component 1710 may determine a controlled delay parameter. With reference to FIG. 6, it may be seen that each stream may have varying delay values. Steering law component 1710 may determine the controlled delay parameter for each stream by executing an algorithm. An exemplary pseudo code algorithm may be expressed as follows:

| Tau_Max = max(Real_Delay); | |
|---|---|
| for | i = 1 : Nspeaker s{ |

Delay_Law(i) = Tau_Max − Real_Delay(i);

}

where Tau_Max=the maximum delay from each speaker to acoustic sensors and Delay_Law=the amount of additional delay to add to each input signal to speakers 110 and 115.

FIG. 19 illustrates a flowchart 1900 of an exemplary method performed by noise steering component 1720 (FIG. 17), consistent with the invention. Noise steering component 1720 may determine the mixing of signals necessary to remove the noise signals identified by navigation module 210. Noise steering component 1720 may superimpose a cancellation signal on the noise signals in audio environment 100, such that at the specified listener location no noise is heard. This may be shown in the following equation:
−M*\vec{N}=R*Cₙ*\vec{N},
where M represents an attenuation matrix, N represents a known noise stream, R represents the slow correction matrix determined by pattern recognition component 430, and Cₙ represents a linear transform for noise.

At step 1910, noise steering component 1720 may receive the noise dynamics at a specified listener location (real_noise_mixing), the speaker controller law (steering_law), and the minimum attenuation (alpha_min).

At step 1920, noise steering component 1720 may calculating the noise steering law, for example, as follows:
NOISE_STEERING_LAW=−alpha_min*mat_mult(STEERING_LAW REAL_NOISE_MIXING);
where NOISE_STEERING_LAW=the Noise Mixing Matrix; alpha_min=the minimum attenuation value for the noise as sensed at the specified listener location; mat_mult=a matrix multiplication function; STEERING_LAW=the non-noise mixing matrix; and REAL_NOISE_MIXING=the mixing estimate of the noise as sensed at the specified listening location.

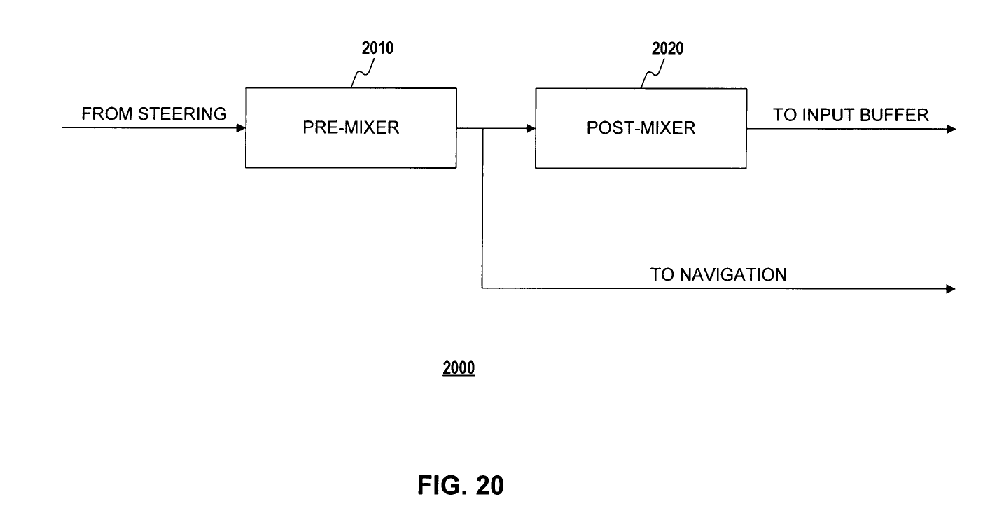

FIG. 20 is an exemplary functional block diagram of the control section 2000 of steering and control module 230, consistent with the invention. Control section 2000 may implement the steering law and the noise law provided by the steering component. Control section 2000 may mix the audio input signals, the steering law signal, and the noise law signal before input to speakers 110 and 115. Control section 2000 may also buffer and store audio signals from the previous sample by sensor array 190 for use by correlation 410.

Pre-mixer component 2010 may mix the audio input signal and the steering law to create a pre-mix signal. The pre-mix signal may be used to correct based on imperfections in the arrangement of audio environment 100. Pre-mixer 2010 may determine how to mix audio signals to provide balanced sound streams from speakers 110 and 115 at a specified listener location in audio environment 100. The audio input signal may be a signal generated by an audio source (a CD player, a DVD player, the radio, etc.), that a listener wishes to reproduce. The pre-mix signal may be delayed by the controlled delay parameter determined by steering 1710.

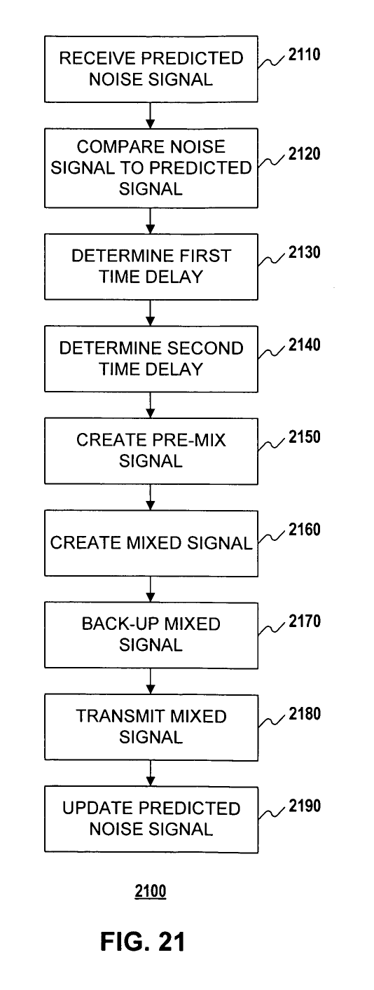

FIG. 21 illustrates a flowchart of an exemplary method 2100 that may be performed by post-mixer component 2020 (FIG. 20), consistent with the invention. Post-mixer component 2020 may determine the best way to mix the pre-mix signal with the noise law. Post-mixer component 2020 may use a feedback controller to remove noise. Post-mixer component 2020 may determine the delays necessary in the noise law so that the real noise can be canceled at the specified listener location. If the real noise is canceled by a cancellation noise signal, this cancellation noise signal will appear to be noise in other locations of audio environment 100, such as at sensor array 190. Accordingly, post-mixer component 2020 may predict what the cancellation noise signal will be at sensor array 190, and use any deviation to update the noise law. Post-mixer component 2020 may use buffered signals generated by sensor array 190 from previous sample groups.

At step 2110, post-mixer component 2020 may receive the predicted noise signal. The predicted noise signal may be received from the previous iteration at step 2190.

At step 2120, post-mixer component 2020 may compare the received noise signal to the predicted noise signal. An error term may be created from the previous iteration. The error term, noise_error, may be calculated from the previous noise estimate, old_estimate, and the noise received from noise stripper component 420, as follows:
Noise_error=old_estimate−noise.

At step 2130, post-mixer component 2020 may determine a first time delay for noise between the specified listener location and sensor array 190. Post-mixer component 2020 may determine the time delay by executing an algorithm. An exemplary pseudo code algorithm may be expressed as follows:

dot_val = samp_freq* dot(mic2sweet_vec,Noise_Unit_Vec[i,:])/speed
_sound;
noise_delay(i) = dot_val − mod(dot_val,samp_freq);

where Dot=the dot product operator; mic2sweet_vec=the microphone to specified listener location vector in Cartesian coordinates; Noise_Unit_Vec=the direction of the noise sources; speed sound=the speed of sound in the room; samp_freq=the sample frequency; and dot_val=the dot product value of mic2sweet_vec and Noise_Unit_Vec.

At step 2140, post-mixer component 2020 may determine a second time delay for noise between the specified listener location and each of speakers 110 and 115. The second time delay may be determined by a number of sample delays specified the speaker distance. The second time delay may be determined by executing an algorithm. An exemplary pseudo code algorithm may be expressed as follows:

samp_val = samp_freq* Sweet_Polar(i,1)/speed_sound;
speaker_delay(i) = samp_val − mod(samp_val,samp_freq);

where Sweet_Polar=the location of the specified listener location in polar coordinates and NN_Noise=the noise estimate from the pattern recognition function.

At step 2150, post-mixer component 2020 may create a pre-mix signal by backing up samples equivalent to the first time delay. This may allow the noise signals to be advanced to account for the time delay between the specified listener location and sensor array 190. Because the distances between each speaker and the specified listener location may vary, post-mixer 2020 must ensure that the noise cancellation signals generated by speakers 110 and 115 arrive at the specified listener location at appropriate time. The noise signals may be advanced by executing an algorithm. An exemplary pseudo code algorithm may be expressed as follows:

| | |
|---|---|
| for | i = 1 : Nnoise{ |

begin = noise_delay(i);
number = end − begin+1;
Pr e_Mixer(i,1: number) = NN_Noise(i,begin : end);
Pr e_Mixer(i,number + 1: end) = 0;

}

where end=the last element in the noise vector and lengths are chosen such that zero values are not sent to speakers 110 and 115. NN_Noise is the noise estimation from pattern recognition 430.

At step 2160, post-mixer component 2020 may create a mixed signal between the input signal, the pre-mixer signal, and the noise steering law by executing an algorithm. An exemplary pseudo code algorithm may be expressed as follows:

| | |
|---|---|
| for | i = 1 : Nspeaker s{ |

| | |
|---|---|
| for | j = 1 : Nnoise{ |

Speaker_Mix(i,:) = Speaker_Mix(i,:)+ Pr e_Mixer(j,:)*
NOISE_STEERING_LAW(i,j);

}

}

where Nspeakers=the number of speakers; NOISE_STEERING_LAW=the noise mixing matrix; Pre_Mixer=the pre-mix signal; Speaker Mix=the mixed input signal for speakers 110 and 115.

At step 2170, post-mixer component 2020 may back up the mixed signal so that the transmitted sound stream will arrive at the specified listener location at the proper time by executing an algorithm. An exemplary pseudo code algorithm may be expressed as follows:

| | |
|---|---|
| for | i = 1 : Nspeaker s{ |

first = speaker_delay(i);
last = first + nsamples − 1;
Speaker_Output(1,:) = −Speaker_Mix(i,first : last);

}

where Speaker_Output=the resulting delayed input signal to speakers 110 and 115.

At step 2180, post-mixer component 2020 may input the mixed signal to speakers 110 and 115 for reproduction as sound signals.

At step 2190, post-mixer component 2020 may update the predicted noise signal. The predicted noise signal may identify the noise that the system expects to receive by sensor array 190 (expected noise). To identify the expected noise, post-mixer component 2020 may first determine the attenuation of noise from the noise sources to sensor array 190. Next, post-mixer component 2020 may determine the attenuation of noise from speakers 110 and 115 to sensor array 190. These attenuations of noise may be stored in matrices calculated by executing an algorithm. An exemplary pseudo code algorithm may be expressed as follows:

| | |
|---|---|
| for | i = 1 : NSensors{ |

| | |
|---|---|
| for | j = 1: Nnoise{ |

Noise2Sensors(i,j) = Alpha_Noise(j)*
microphone(Noise_Theta(j)− Psi(i));

}

}

where NSensors=the number of microphones in sensor array 190; Nnoise=the number of noise streams; Noise2Sensors=the attenuation of noise from the virtual noise sources to acoustic sensors.

With these matrices, post-mixer component 2020 may calculate what noise is expected in the stripped noise system by executing an algorithm. An exemplary pseudo code algorithm may be expressed as follows:

| | |
|---|---|
| for | i = 1 : Nmics{ |

| | |
|---|---|
| for | j = 1 : Nnoise{ |

New_Estimate(i,:) = New_Estimate(i,:)+ NN_Noise(j,1 :
nsamples)* Noise2Mics(i,j);

| } | |
|---|---|
| for | j = 1 : Nspeak{ |

| | |
|---|---|
| if | i == 1{ |

Speak_Data(j,:) = [Old_Anti_Noise(j,end − Delay + 1:
end),Speaker_Output(i,Delay : end)];

}
New_Estimate(i,:) = New_Estimate(i,:)+ Speak_Data(j,:)*
ATTENUATION_EST(i,j);

}

}

where:
Nmics=the number of microphones in sensor array 190;
Nnoise—the number of noise streams;
New_Estimate=the predicted noise;
NN_Noise=the expected noise identified by pattern recognition;
Noise2Mics=the mixing of noise from the virtual noise sources to sensor array 190;
Speak_Data=a buffer that combines the previous noise cancellation signal with data output to speakers 110 and 115;
Old_Anti_Noise=previous data sent to speakers 110 and 115 to mitigate noise;
Speaker_Output=previous mixed signal sent to speakers 110 and 115; and
ATTENUATION_EST=the estimated attenuation from speakers 110 and 115 to sensor array 190.

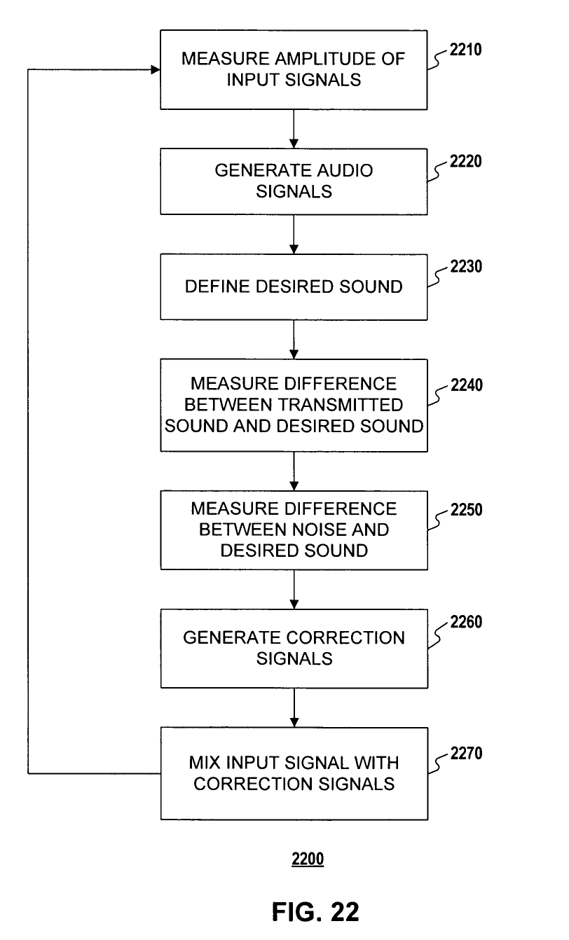

FIG. 22 illustrates a flowchart of an exemplary method 2200 performed by system 200 (FIG. 2), consistent with the invention.

At step 2210, system 200 may measure the amplitude of audio input signals to speakers 110 and 115. The amplitude may be measured by using processor 305 (FIG. 3) as described above.

At step 2220, sensor array 190 may generate audio signals.

At step 2230, system 200 may define a desired sound signal that will produce a desired sound field at a specified listener location in audio environment 100.

At step 2240, system 200 may measure a first difference between the input signal to speakers 110 and 115 and the desired sound signal.

At step 2250, system 200 may measure a second difference between noise signals from sensor array 190 and the desired sound signal.

At step 2260, system 200 may generate one or more correction signals that correct the first and second differences when mixed with the audio input signal.

At step 2270, system 200 may mix the input signal with the correction signals to create a mixed signal. The mixed signal may then be transmitted to speakers 110 and 115.

The audio signals described throughout the specification may be implemented as matrices. The systems and methods described herein may be implemented using timing specifications such that the outputs of each module or component are available at the proper time as an input to module or component that receives the output. Moreover, the systems described may be executed using parallel processing techniques.

System 200 may utilize two modes of operation: set-up and run-time. The set-up mode may be used at initial set-up of the system to determine the relative locations of speakers 110 and 115, the specified listener location, and how to correct for speakers that are not placed in their optimum positions. The run-time mode may be executed continuously after set-up is complete to determine the orientation of sensor array 190, detect external noise sources, and cancel repetitive noise sources as described above.

The execution order, starting with the first component to be executed, of the components in set-up mode may be, for example: correlation component 410, filter 415, location component 435, coordinate frame component 455, sonic estimation component 465, desired sound component 1620, and steering law component 1710. The execution order, starting with the first component to be executed, of the components in the run-time mode may be, for example: correlation component 410, filter 415, noise stripper component 420, location component 435, pattern recognition component 430, noise location component 445, noise steering component 1720, pre-mixer component 2010, and post-mixer component 2020.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A computer-readable medium comprising program code instructions which, when executed in a processor, perform a method for monitoring acoustic characteristics of an audio environment, the audio environment including a plurality of sound sources converting audio signals to first sound streams and undesired objects producing second sound streams, the method comprising:
monitoring the audio signals;
generating, by a plurality of acoustic sensors, sound signals corresponding to the first sound streams and the second sound streams;
calculating attenuation and delay values between the audio signals and the sound signals; and
using the attenuation and delay values to identify at least portions of the sound signals corresponding to second sound streams.

2. A computer-readable medium according to claim 1, wherein calculating comprises comparing an amplitude of the audio signals to an amplitude of the sound signals.

3. A computer-readable medium according to claim 1, wherein the method further comprises measuring an amplitude of the second sound streams, the measuring comprising comparing the amplitude of the sound signals to an amplitude of a noise cancellation signal supplied to the sound sources.

4. A computer-readable medium according to claim 1, wherein the sound sources comprise speakers.

5. A computer-readable medium according to claim 1, wherein the method further comprises:
monitoring the sound signals over a period of time;
averaging the attenuation of the sound signals over the period of time; and
averaging the delay of the sound signals over the period of time.

6. A computer-readable medium according to claim 1, wherein the method further comprises determining one or more patterns of noise in the second sound streams.

7. A computer-readable medium according to claim 1, wherein the method further comprises:
determining a location of the sound sources in the audio environment; and
determining a location of the undesired objects in the audio environment.

8. A computer-readable medium according to claim 7, wherein the method further comprises:
establishing a coordinate frame with respect to a location in the audio environment; and
determining the location of the sound sources and the undesired objects with respect to the coordinate frame.

9. A computer-readable medium comprising program code instructions which, when executed in a processor, perform a method for generating a desired sound stream at a specified listener location in an audio environment, the audio environment including a plurality of sound sources converting audio signals to first sound streams and undesired objects producing second sound streams, the method comprising:
measuring an amplitude of the audio signals;
generating, by a plurality of acoustic sensors, sound signals corresponding to the first sound streams and the second sound streams;
defining one or more desired sound streams at the specified listener location;
processing the sound signals to determine a difference between the first sound streams and the desired sound streams;
processing the sound signals to determine a difference between the second sound streams and the desired sound streams;
generating correction signals to modify the audio signals; and
mixing the audio signals with the one or more correction signals to produce the desired sound streams at the specified listener location.

10. A computer-readable medium according to claim 9, wherein the method further comprises:
calculating attenuation and delay values between the audio signals and the sound signals;
correlating the attenuation and delay values to produce correlation values;
using the correlation values to identify the second sound streams.

11. A computer-readable medium according to claim 9, wherein defining a desired sound stream comprises:
determining a number of sound streams in the audio environment; and
determining, using the number of sound streams, a specified placement of the sound sources in relation to the specified listener location in the audio environment.

12. A computer-readable medium comprising program code instructions which, when executed in a processor, perform a method for reducing effects of noise in an audio environment, the method comprising:
creating a noise signal by detecting one or more noise streams in the audio environment;
comparing the noise signal to a predicted audio signal;
determining a first time delay for the noise streams between a specified listener location in the audio environment and a plurality of acoustic sensors;
determining a second time delay for the noise streams between the specified listener location and one or more sound sources;
creating a pre-mix signal by advancing an audio signal by the first time delay;
creating a mixed signal by mixing the pre-mix signal with an attenuation signal calculated to generate a sound stream that cancels the predicted noise signal;
advancing the mixed signal by the second delay;
outputting the mixed signal; and
updating the predicted audio signal from the mixed signal.

13. A computer-readable medium comprising program code instructions which, when executed in a processor, perform a method for generating a desired sound field at a desired location by sound streams produced by a plurality of speakers connected to corresponding terminals of an audio device, the terminals supplying audio signals corresponding to designated locations with respect to the desired location, the speakers being located at actual locations different from the designated locations, the method comprising:
supplying audio signals to the speakers to produce sound streams;
generating sound signals corresponding to the sound streams;
deriving, from the generated sound signals, position information identifying the actual locations of the speakers;
modifying the audio signals in accordance with the position information; and
transmitting the modified audio signals from the terminals to the speakers to produce the desired sound field at the desired location.

14. A computer-readable medium according to claim 13, wherein deriving comprises:
establishing a coordinate frame with respect to a location in the audio environment; and
determining the actual locations of the speakers with respect to the coordinate frame.

15. A computer-readable medium comprising program code instructions which, when executed in a processor, perform a method for mitigating the effect of noise in a sound field of an audio environment, the method comprising:
detecting a sound field created by first sound streams generated by desired sound signals supplied to desired sound sources, and a second sound stream generated by an undesired sound source;
creating a virtual noise source signal having properties corresponding to the second sound stream;
creating a correction signal using the virtual noise source signal;
mixing the correction signal with the desired sound signals;
supplying the mixed signal to the desired sound sources; and
adjusting the correction signal so as to reduce the effect of the second sound stream on the sound field.

16. A computer-readable medium as recited in claim 15, wherein adjusting comprises adjusting the correction signal so as to eliminate the effect of the second sound stream on the sound field.

17. A system for monitoring acoustic characteristics of an audio environment, the audio environment including a plurality of sound sources converting audio signals to first sound streams and undesired objects producing second sound streams, comprising:
a plurality of acoustic sensors for generating sound signals corresponding to the first sound streams and the second sound streams;
a first processor component for calculating attenuation and delay values between the audio signals and the sound signals; and
a second processor component for using the attenuation and delay values to identify portions of the sound signals corresponding to second sound streams.

18. A system for generating a desired sound stream at a specified listener location in an audio environment, the audio environment including a plurality of sound sources converting audio signals to first sound streams and undesired objects producing second sound streams, comprising:
a first processor component for measuring an amplitude of one or more of the audio signals;
a digital input circuit for receiving a plurality of sound signals corresponding to the first sound streams and the second sound streams;
a component for defining a plurality of desired sound streams at the specified listener location;
a second processor component for processing the sound signals to determine a difference between the first sound streams and the desired sound streams;
a third processor component for processing the sound signals to determine a difference between the second sound streams and the desired sound streams;
a fourth processor component for generating correction signals to modify the audio signals; and
a circuit for mixing the audio signals with the correction signals to produce the desired sound streams at the specified listener location.

19. A system for reducing effects of noise in an audio environment, comprising:
means for creating a noise signal by detecting one or more noise streams in the audio environment;
means for comparing the noise signal to a predicted audio signal;
means for determining a first time delay for the noise streams between a specified listener location in the audio environment and a plurality of acoustic sensors;
means for determining a second time delay for the noise streams between the specified listener location and a plurality of sound sources;
means for creating a pre-mix signal by advancing an audio signal by the first time delay;
means for creating a mixed signal by mixing the pre-mix signal with an attenuation signal calculated to generate a sound stream that cancels the predicted noise signal;
means for advancing the mixed signal by the second delay;
a plurality of terminals outputting the mixed signal; and
means for updating the predicted audio signal from the mixed signal.

20. A system for generating a desired sound field at a desired location by sound streams produced by a plurality of speakers connected to corresponding terminals of an audio device, the terminals supplying audio signals corresponding to designated locations with respect to the desired location, the speakers being located at actual locations different from the designated locations, the system comprising:
a plurality of terminals for supplying audio signals to the speakers to produce sound streams;
a plurality of acoustic sensors for generating sound signals corresponding to the sound streams; and
means for deriving, from the generated sound signals, position information identifying the actual locations of the speakers;
means for modifying the audio signals in accordance with the position information to produce the desired sound field at the desired location.

21. A system for mitigating the effect of noise in a sound field of an audio environment, the system comprising:
a plurality of acoustic sensors for detecting a sound field created by first sound streams generated by desired sound signals supplied to desired sound sources, and a second sound stream generated by an undesired sound source;
a first processor component for creating a virtual noise source signal having properties corresponding to the undesired sound stream;
a second processor component for creating a correction signal using the virtual noise source signal;
a third processor component for mixing the correction signal with the desired sound source signal;
a plurality of terminals for supplying the mixed signal to the desired sound sources; and
a fourth processor component for adjusting the correction signal so as to reduce the effect of the second sound stream on the sound field.

22. A method for monitoring acoustic characteristics of an environment, the environment including a plurality of sound sources converting audio signals to first sound streams and undesired objects producing second sound streams, comprising:
monitoring the audio signals;
generating, by a plurality of acoustic sensors, sound signals corresponding to the first sound streams and the second sound streams;
calculating attenuation and delay values between the audio signals and the sound signals; and
using the attenuation and delay values to identify portions of the sound signals corresponding to second sound streams.

23. A method for generating a desired sound stream at a specified listener location in an audio environment, the environment including a plurality of sound sources converting audio signals to first sound streams and undesired objects producing second sound streams, comprising:
measuring an amplitude of the audio signals;
generating, by a plurality of acoustic sensors, sound signals corresponding to the first sound streams and the second sound streams;
defining desired sound streams at the specified listener location;
processing the sound signals to determine a difference between the first sound streams and the desired sound streams;
processing the sound signals to determine a difference between the second sound streams and the desired sound streams;
generating correction signals to modify the audio signals; and
processing the audio signals with the one or more correction signals to produce the desired sound streams at the specified listener location.

24. A method for reducing effects of noise in an audio environment, comprising:
creating a noise signal by detecting one or more noise streams in the audio environment;
comparing the noise signal to a predicted noise signal;
determining a first time delay for the noise streams between a specified listener location in the audio environment and a plurality of acoustic sensors;
determining a second time delay for the noise streams between the specified listener location and a plurality of sound sources;
creating a pre-mix signal by advancing an audio signal by the first time delay;
creating a mixed signal by mixing the pre-mix signal with an attenuation signal calculated to generate a sound stream that cancels the predicted noise signal;
advancing the mixed signal by the second delay;
outputting the mixed signal; and
updating the predicted audio signal from the mixed signal.

25. A method for generating a desired sound field at a desired location by sound streams produced by a plurality of speakers connected to corresponding terminals of an audio device, the terminals supplying audio signals corresponding to designated locations with respect to the desired location, the speakers being located at actual locations different from the designated locations, the method comprising:
supplying audio signals to the speakers to produce sound streams;
generating sound signals corresponding to the sound streams;
deriving, from the generated sound signals, position information identifying the actual locations of the speakers;
modifying the audio signals in accordance with the position information; and
transmitting the modified audio signals from the terminals to the speakers to produce the desired sound field at the desired location.

26. A method for mitigating the effect of noise in a sound field of an audio environment, the method comprising:
detecting a sound field created by first sound streams generated by desired sound signals supplied to desired sound sources, and a second sound stream generated by an undesired sound source;
creating a virtual noise source signal having properties corresponding to the second sound stream;
creating a correction signal using the virtual noise source signal;
mixing the correction signal with the desired sound signals;
supplying the mixed signal to the desired sound sources; and
adjusting the correction signal so as to reduce the effect of the second sound stream on the sound field.
